(19) United States
(12) Patent Application Publication
(10) Pub. No.: US 2024/0430741 A1
(43) Pub. Date: Dec. 26, 2024

(54) F1 ENHANCEMENT FOR PDCP STATUS REPORTING

(71) Applicant: QUALCOMM Incorporated, San Diego, CA (US)

(72) Inventors: Toru UCHINO, Zushi-shi (JP); Prasad Reddy KADIRI, San Diego, CA (US); Bharat SHRESTHA, San Diego, CA (US); Umesh PHUYAL, San Diego, CA (US); Xiao Feng WANG, San Diego, CA (US); Alberto RICO ALVARINO, San Diego, CA (US)

(21) Appl. No.: 18/339,219

(22) Filed: Jun. 21, 2023

(51) Int. Cl. H04W 28/04; H04L 1/08

(52) U.S. Cl. CPC H04W 28/04; H04L 1/08

(57) ABSTRACT

This disclosure provides methods, components, devices and systems for enhanced downlink and uplink scheduling based on assistance information related to PDCP status reports. Some aspects specifically relate to a wireless communication system including a disaggregated base station architecture in which a CU provides a DU assistance information related to PDCP status reports from which assistance information the DU may determine appropriate downlink or uplink scheduling start timing for a UE. In some examples, the DU obtains from the CU assistance information indicating an unreceived PDCP SDU at a UE or the CU, and sends downlink data or an uplink grant to the UE based on the assistance information. The CU may deliver the downlink data to the DU prior to sending the assistance information or obtain uplink data from the DU after sending the assistance information. Duplication of PDCP SDU transmissions and unnecessarily extended scheduling delays may thus be minimized.

### TECHNICAL FIELD

The present disclosure generally relates to wireless communication, and more particularly, to a wireless communication system providing enhanced downlink and uplink scheduling based on assistance information related to Packet Data Convergence Protocol (PDCP) status reports.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure can be implemented in a method for wireless communication performable at a first network entity. The method includes obtaining, from a second network entity, assistance information indicating an unreceived Packet Data Convergence Protocol (PDCP) service data unit (SDU) at a user equipment (UE) or the second network entity, and sending downlink data or an uplink grant to the UE based on the assistance information.

Another innovative aspect of the subject matter described in this disclosure can be implemented in an apparatus for wireless communication. The apparatus includes one or more memories, and one or more processors each communicatively coupled with at least one of the one or more memories. The one or more processors, individually or in any combination, are operable to cause the apparatus to obtain, from a network entity, assistance information indicating an unreceived PDCP SDU at a UE or the network entity, and send downlink data or an uplink grant to the UE based on the assistance information.

In some examples of the methods, the first network entity is a distributed unit (DU), and the second network entity is a central unit (CU). In some examples of the methods, the first network entity is in a satellite, the second network entity is in a ground station, and the first network entity and the second network entity are part of a non-terrestrial network (NTN).

In some examples of the apparatuses, the apparatus is a DU, and the network entity is a CU. In some examples of the apparatuses, the apparatus is in a satellite, the network entity is in a ground station, and the apparatus and the network entity are part of a NTN.

In some examples of the methods and apparatuses, the DU is a target DU following a handover of the UE from a source DU.

Another innovative aspect of the subject matter described in this disclosure can be implemented in a method for wireless communication performable at a first network entity. The method includes sending, to a second network entity, assistance information indicating an unreceived PDCP SDU at a UE or the first network entity, and one of: delivering downlink data to the second network entity prior to sending the assistance information indicating the unreceived PDCP SDU at the UE, or obtaining uplink data from the second network entity after sending the assistance information indicating the unreceived PDCP SDU at the first network entity.

Another innovative aspect of the subject matter described in this disclosure can be implemented in an apparatus for wireless communication. The apparatus includes one or more memories, and one or more processors each communicatively coupled with at least one of the one or more memories. The one or more processors, individually or in any combination, are operable to cause the apparatus to send, to a network entity, assistance information indicating an unreceived PDCP SDU at a UE or the apparatus, and one of: deliver downlink data to the network entity prior to sending the assistance information indicating the unreceived PDCP SDU at the UE, or obtaining uplink data from the network entity after sending the assistance information indicating the unreceived PDCP SDU at the apparatus.

In some examples of the methods, the first network entity is a CU, and the second network entity is a DU. In some examples of the methods, the first network entity is in a ground station, the second network entity is in a satellite, and the first network entity and the second network entity are part of a NTN.

In some examples of the apparatuses, the apparatus is a CU, and the network entity is a DU. In some examples of the apparatuses, the apparatus is in a ground station, the network entity is in a satellite, and the apparatus and the network entity are part of a NTN.

In some examples of the methods and apparatuses, the DU is a target DU following a handover of the UE from a source DU.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first subframe within a 5G New Radio (NR) frame structure.

FIG. 2B is a diagram illustrating an example of downlink (DL) channels within a 5G NR subframe.

FIG. 2C is a diagram illustrating an example of a second subframe within a 5G NR frame structure.

FIG. 2D is a diagram illustrating an example of uplink (UL) channels within a 5G NR subframe.

FIG. 3 is a block diagram of a first wireless device in communication with a second wireless device in an access network.

FIG. 4 is a diagram illustrating an example of a call flow between a user equipment (UE), a source base station prior to a handover of the UE, and a target base station after a handover of the UE.

FIG. 5 is a diagram illustrating an example of a network in which a central unit (CU) and a distributed unit (DU) of a disaggregated base station are responsible for different functional layers of a protocol stack.

FIG. 6 is a diagram illustrating an example of a call flow between a UE, a source DU prior to a handover of the UE, a target DU after a handover of the UE, and a CU in a disaggregated base station architecture.

FIG. 7 is a diagram illustrating an example of a call flow between a UE, a source DU prior to a handover of the UE, a target DU after a handover of the UE, and a CU which controls delivery timing of downlink data to the target DU to coincide with reception of a Packet Data Convergence Protocol (PDCP) status report.

FIG. 8 is a diagram illustrating an example of a chart showing feeder link traffic over time prior to and following a handover when a CU controls downlink data delivery to occur following reception of a PDCP status report.

FIG. 9 is a diagram illustrating an example of a call flow between a UE, a source DU prior to a handover of the UE, a target DU after a handover of the UE, and a CU which provides assistance information to the target DU for downlink scheduling.

FIG. 10 is a diagram illustrating an example of a call flow between a UE, a source DU prior to a handover of the UE, a target DU after a handover of the UE, and a CU which provides assistance information to the target DU for uplink scheduling.

FIG. 11 is a flowchart of an example method or process for wireless communication performable at a network entity which performs enhanced downlink and uplink scheduling based on assistance information related to PDCP status reports.

FIG. 12 is a flowchart of an example method or process for wireless communication performable at a network entity which performs enhanced downlink scheduling based on assistance information related to PDCP status reports.

FIG. 13 is a flowchart of an example method or process for wireless communication performable at a network entity which performs enhanced uplink scheduling based on assistance information related to PDCP status reports.

FIG. 14 is a flowchart of an example method or process for wireless communication performable at a network entity which provides assistance information related to PDCP status reports for enhanced downlink and uplink scheduling.

FIG. 15 is a flowchart of an example method or process for wireless communication performable at a network entity which provides assistance information related to PDCP status reports for enhanced downlink scheduling.

FIG. 16 is a flowchart of an example method or process for wireless communication performable at a network entity which provides assistance information related to PDCP status reports for enhanced uplink scheduling.

FIG. 17 is a diagram illustrating an example of a hardware implementation for an apparatus which is a DU.

FIG. 18 is a diagram illustrating an example of a hardware implementation for an apparatus which is a CU.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspects generally relate to a wireless communication system providing enhanced downlink and uplink scheduling based on assistance information related to Packet Data Convergence Protocol (PDCP) status reports. More particularly, aspects specifically relate to a wireless communication system including a disaggregated base station architecture in which a central unit (CU) provides a distributed unit (DU) assistance information related to PDCP status reports from which assistance information the DU may determine appropriate downlink or uplink scheduling start timing for a user equipment (UE). The assistance information may be communicated for example over an F1 interface between the CU and the DU. These aspects may apply to any situation in which PDCP retransmissions are triggered and a PDCP status report is sent, including, but not limited to, handovers and RRC re-establishment procedures. In some aspects, the CU and DU may be in a non-terrestrial network (NTN); for example, the CU may be a ground station and the DU may be a satellite. In some aspects, the DU may be a target DU in a handover from a source DU, or the DU may be a single DU in the absence of a handover.

In one example related to downlink (DL) scheduling, a CU delivers DL data to a DU before the CU receives a PDCP status report indicating unreceived downlink PDCP service data units (SDUs) from a UE. The DU buffers the DL data received from CU. In response to receiving the PDCP status report from the UE, the CU determines the unreceived downlink PDCP SDUs the UE indicated in the status report, and the CU provides assistance information to the DU indicating the PDCP protocol data units (PDUs) or SDUs the DU is to retransmit to the UE (the unreceived PDCP SDUs). The assistance information may also indicate whether or not the DU is to discard any PDCP downlink PDUs or SDUs carrying downlink data from the CU which the UE had previously received, and if so, which PDCP downlink PDUs or SDUs the DU is to discard prior to performing downlink data scheduling. The CU may also provide a assistance information to the DU indicating to expect further assistance information from the CU prior to scheduling downlink data for UE, if for example the DU does not have the capability to autonomously expect to receive such further assistance information prior to performing downlink data scheduling. After receiving the assistance information from the CU, the DU then begins scheduling downlink data based on the assistance information.

In one example related to uplink (UL) scheduling, a CU prepares a PDCP status report indicating one or more unreceived PDCP uplink SDUs from a UE. Afterwards, the CU delivers DL data including the PDCP status report to a DU for the DU to provide to the UE. The CU may also deliver DL data including some other indication of the unreceived PDCP uplink SDUs at the CU. To trigger the DU to consider this information before performing uplink scheduling for the UE, the CU provides the DU assistance information indicating the PDCP status report or otherwise the unreceived PDCP uplink SDUs at the CU. The CU may also provide assistance information to the DU indicating to expect further assistance information from the CU prior to scheduling uplink data of the UE, if for example the DU does not have the capability to autonomously expect to receive such further assistance information prior to performing uplink data scheduling. After the CU provides the assistance information to the DU, the DU may decode the downlink data for the PDCP status report or other indication of the unreceived PDCP uplink SDUs at the CU, and the DU may subsequently begin uplink scheduling for the unreceived SDUs of the UE. If the UE is configured to send duplicate transmissions prior to reception of the PDCP status report, such as in cases of multiple data radio bearers or logical channels having different priorities, the DU may select which PDCP PDUs of the UE may be delivered to the CU or discarded without delivery to the CU without UE involvement. Alternatively, the UE may temporarily suspend PDCP data PDU transmissions after PDCP retransmissions are triggered.

Particular aspects of the subject matter described in this disclosure can be implemented to realize one or more of the following potential advantages for downlink scheduling. For instance, by allowing the CU to provide assistance information to the DU indicating the DU to wait until after the PDCP status report is received before sending downlink PDCP PDUs to the UE, duplication of PDCP SDU transmissions and unnecessarily extended scheduling delays may be minimized or avoided. Moreover, by allowing the CU to deliver downlink data to the DU before the CU receives the PDCP status report, feeder link congestion on the downlink may be minimized in handovers resulting from moving satellites. Furthermore, by allowing the CU to optionally provide assistance information to the DU which indicates the DU to expect subsequent reception of further assistance information prior to performing downlink scheduling, the likelihood of the DU performing inefficient scheduling based on differences in capability between the CU and DU may be similarly minimized or avoided.

Particular aspects of the subject matter described in this disclosure can be implemented to realize one or more of the following potential advantages for uplink scheduling. For instance, by allowing the CU to provide assistance information to the DU indicating the DU to wait until after the PDCP status report is transmitted, acknowledged, or expected to be received at the UE before scheduling uplink PDCP PDUs from the UE, duplication of PDCP SDU transmissions and unnecessarily extended scheduling delays may be minimized or avoided. Moreover, by allowing the CU to optionally provide assistance information to the DU which indicates the DU to expect subsequent reception of further assistance information prior to performing uplink scheduling, the likelihood of the DU performing inefficient scheduling based on differences in capability between the CU and DU may be similarly minimized or avoided. Furthermore, by allowing the UE to temporarily suspend PDCP data PDU transmissions after PDCP retransmissions are triggered in a functionally split NTN, such approach may prevent the CU and the DU from receiving duplicate PDCP PDUs from UE prior to UE reception of the PDCP status report. Alternatively, by allowing the DU may select which PDCP PDUs of the UE may be delivered to the CU or discarded without delivery to the CU without UE involvement in a functionally split NTN, such approach may prevent the CU from receiving duplicate PDCP PDUs from UE prior to UE reception of PDCP status report without modifications to UE behavior.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

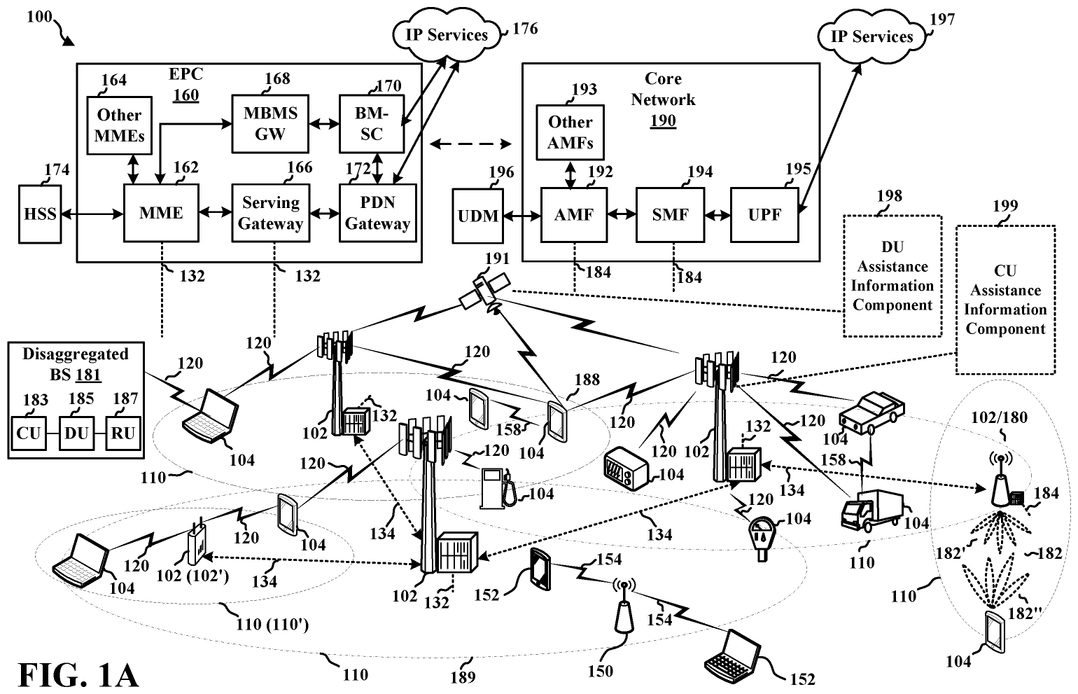

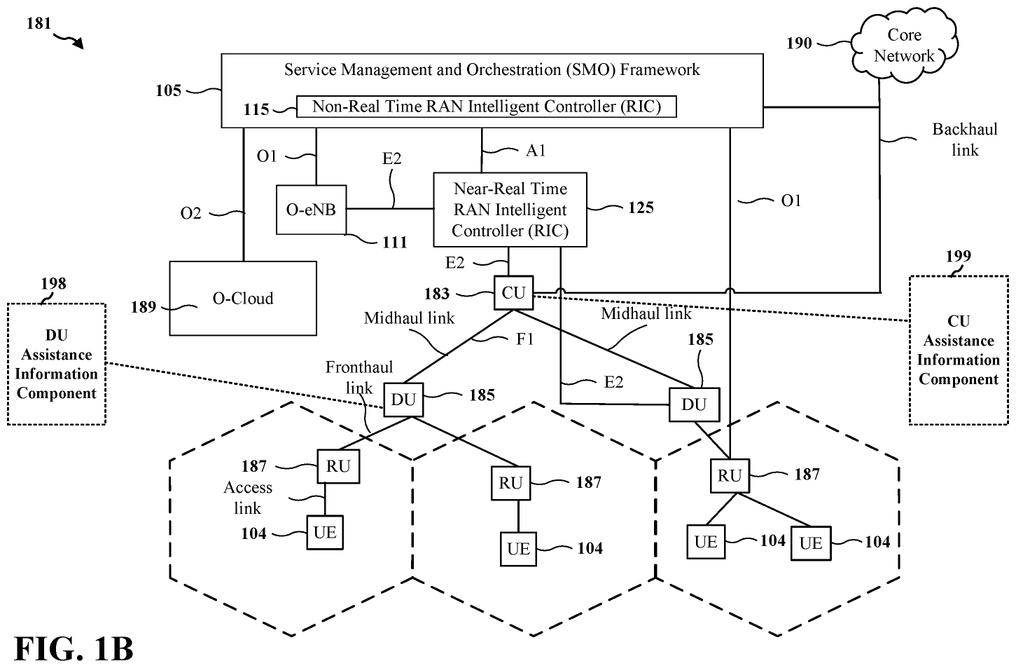

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The wireless communications system and access network 100 may be or include a non-terrestrial network (NTN), a terrestrial network (TN), or a combination of non-terrestrial and terrestrial networks. An NTN is a network involving non-terrestrial flying objects, and may include, but is not limited to, a satellite communication network, a high-altitude platform system (HAPS), or an air-to-ground network, among other networks. Thus, a cell in an NTN may be served by a spaceborne platform such as a low Earth orbiting (LEO) satellite, a medium Earth orbiting (MEO) satellite, or a geosynchronous Earth orbiting (GEO) satellite, an airborne platform such as an International Mobile Telecommunications base station (HIBS), a ground station having antennas up-tilted towards the sky for providing in-flight connectivity, or other base station or network entity providing NTN connectivity. In contrast, a TN is a network that does not involve satellites or other such non-terrestrial flying objects. Thus, a cell in a TN may be served by a ground station or other network entity that provides terrestrial coverage to UEs. In the example wireless communications system and access network 100 of FIG. 1A, NTN cells 188, TN cells 189, or both NTN cells 188 and TN cells 189, may be provided. For example, at least one coverage area 110 or cell may be an NTN cell 188 in which base station 102 provides non-terrestrial coverage to UEs 104 via satellite 191. Alternatively or additionally, at least one other coverage area 110 or cell may be a TN cell 189 in which base station 102 provides terrestrial coverage to UEs 104 (without a satellite intermediary).

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B shows a diagram illustrating an example disaggregated base station 181 architecture. The disaggregated base station 181 architecture may include one or more CUs 183 that can communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 183. The CU 183 may be configured to handle user plane functionality (i.e., Central Unit—User Plane (CU-UP)), control plane functionality (i.e., Central Unit—Control Plane (CU-CP)), or a combination thereof. In some implementations, the CU 183 can be logically split into one or more CU-UP units and one or more CU-CP units. The CU-UP unit can communicate bidirectionally with the CU-CP unit via an interface, such as the E1 interface when implemented in an O-RAN configuration. The CU 183 can be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 185 may further host one or more low PHY layers. Each layer (or module) can be implemented with an interface configured to communicate signals with other layers (and modules) hosted by the DU 185, or with the control functions hosted by the CU 183.

Lower-layer functionality can be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 can be implemented to handle over the air (OTA) communication with one or more UEs 104. In some implementations, real-time and non-real-time aspects of control and user plane communication with the RU(s) 187 can be controlled by the corresponding DU 185. In some scenarios, this configuration can enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements can include, but are not limited to, CUs 183, DUs 185, RUs 187 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the DU 185 may be configured to perform enhanced downlink and uplink scheduling based on assistance information related to PDCP status reports. In particular, the DU 185 may include a DU assistance information component 198 that is configured to obtain, from a network entity, assistance information indicating an unreceived PDCP SDU at a UE or the network entity, and send downlink data or an uplink grant to the UE based on the assistance information. Here, the network entity may be CU 183, and the UE may correspond to UE 104. In certain aspects, the DU 185 of disaggregated base station 181 may be incorporated in satellite 191 as part of an NTN.

Still referring to FIGS. 1A and 1B, in certain aspects, the CU 183 may be configured to provide assistance information related to PDCP status reports for enhanced downlink and uplink scheduling. In particular, the CU 183 may include a CU assistance information component 199 that is configured to send, to a network entity, assistance information indicating an unreceived PDCP SDU at a UE or the CU, and one of: deliver downlink data to the network entity prior to sending the assistance information indicating the unreceived PDCP SDU at the UE, or obtaining uplink data from the network entity after sending the assistance information indicating the unreceived PDCP SDU at the CU. Here, the network entity may be DU 185, and the UE may correspond to UE 104. In certain aspects, the CU 183 of disaggregated base station 181 may be incorporated in a ground station, such as base station 102/180 illustrated in FIG. 1A, and may communicate with DU 185 in satellite 191 as part of an NTN.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

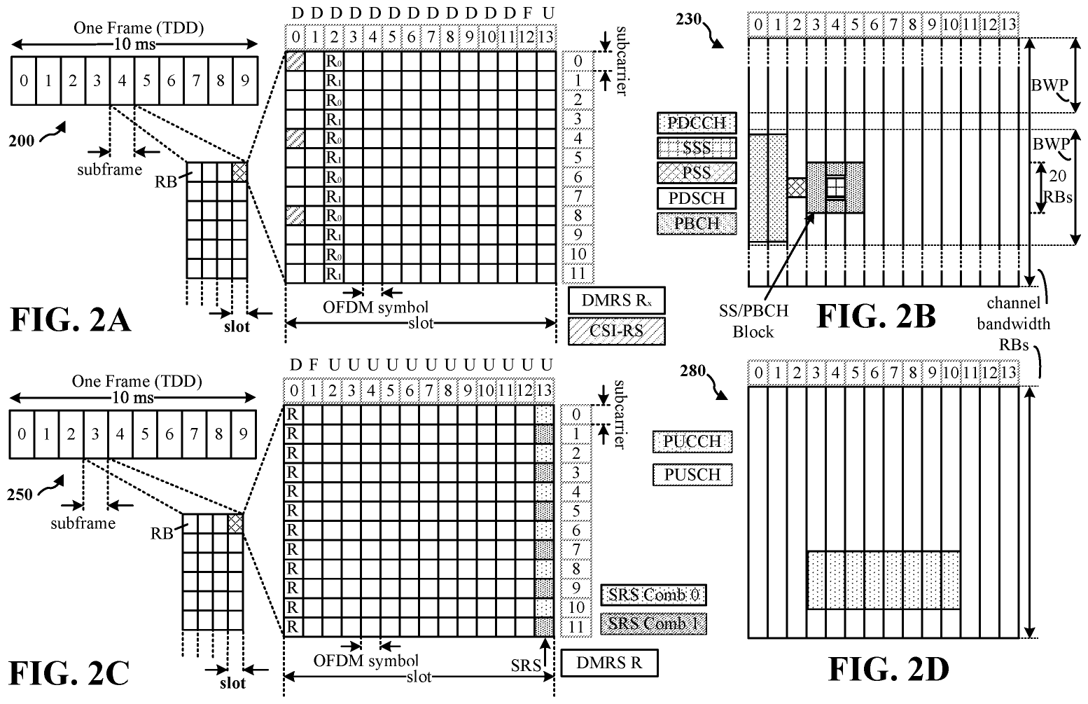

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 slots/subframe. The subcarrier spacing and symbol length/duration are a function of the numerology. The subcarrier spacing may be equal to 2*15 kilohertz (kHz), where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

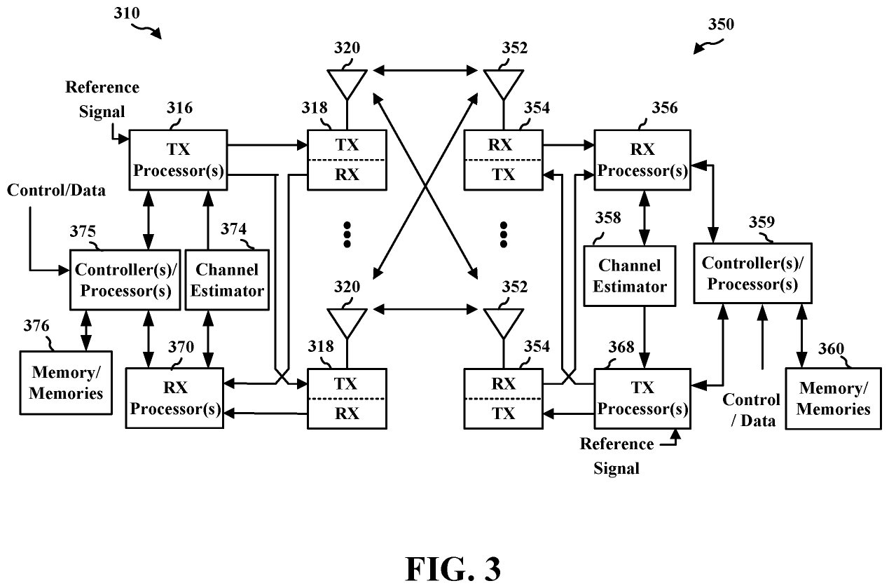

FIG. 3 is a block diagram of a first wireless device 310 in communication with a second wireless device 350 in an access network. In one example, first wireless device 310 may be an aggregated base station, such as base station 102/180, and second wireless device 350 may be a UE, such as UE 104. In another example, first wireless device 310 may be a DU of a disaggregated base station, such as DU 185, and second wireless device 350 may be a UE, such as UE 104. In a further example, first wireless device 310 may be a CU of a disaggregated base station, such as CU 183, and second wireless device 350 may be a DU of the disaggregated base station, such as DU 185. In other examples, first wireless device 310 and second wireless device 350 may respectively be other network entities such as described with respect to FIG. 1A or 1B.

In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer protocol data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the second wireless device 350. Each spatial stream may then be provided to a different antenna 320 via a separate transmitter 318TX. Each transmitter 318TX may modulate an RF carrier with a respective spatial stream for transmission.

At the second wireless device 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the second wireless device 350. If multiple spatial streams are destined for the second wireless device 350, they may be combined by the one or more RX processors 356 into a single OFDM symbol stream. The one or more RX processors 356 then convert the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the first wireless device 310. These soft decisions may be based on channel estimates computed by the channel estimator 358. The soft decisions are then decoded and deinterleaved to recover the data and control signals that were originally transmitted by the first wireless device 310 on the physical channel. The data and control signals are then provided to the one or more controllers/processors 359, which implement layer 3 and layer 2 functionality.

The one or more controllers/processors 359 can each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the first wireless device 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the first wireless device 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the first wireless device 310 in a manner similar to that described in connection with the receiver function at the second wireless device 350. Each receiver 318RX receives a signal through its respective antenna 320. Each receiver 318RX recovers information modulated onto an RF carrier and provides the information to one or more RX processors 370.

The one or more controllers/processors 375 can each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the second wireless device 350. IP packets from the one or more controllers/processors 375 may be provided to the EPC 160. The one or more controllers/processors 375 are also responsible for error detection using an ACK and/or NACK protocol to support HARQ operations.

In one example where the first wireless device 310 is a CU and the second wireless device 350 is a DU, at least one of the one or more TX processors 368, the one or more RX processors 356, and the one or more controllers/processors 359 may be configured to perform aspects in connection with DU assistance information component 198 of FIGS. 1A and 1B, and at least one of the one or more TX processors 316, the one or more RX processors 370, and the one or more controllers/processors 375 may be configured to perform aspects in connection with CU assistance information component 199 of FIGS. 1A and 1B. In another example where the first wireless device 310 is a DU and the second wireless device 350 is a UE, at least one of the one or more TX processors 316, the one or more RX processors 370, and the one or more controllers/processors 375 may be configured to perform aspects in connection with DU assistance information component 198 of FIGS. 1A and 1B.

One of the many functions of the PDCP layer is to perform SDU or PDU retransmissions in response to a handover, an RRC re-establishment procedure, or other PDCP retransmission trigger. For instance, during a handover or re-establishment procedure, the RRC layer may trigger the PDCP layer of a transmitting network entity or wireless device (referred to hereafter as a transmitting PDCP entity) to perform PDCP re-establishment or PDCP data recovery, which in turn leads the transmitting PDCP entity to perform PDCP SDU or PDU transmissions. Moreover, a PDCP layer at a receiving network entity or wireless device (referred to hereafter as a receiving PDCP entity) provides a PDCP status report to the transmitting PDCP entity in attempt to minimize duplicated transmissions for resource efficiency. For instance, when PDCP re-establishment or PDCP data recovery is triggered, the receiving PDCP entity triggers a PDCP status report including a reception status of previous PDCP SDUs or PDUs, which status indicates whether these SDUs or PDUs were received or not received at the receiving PDCP entity, and the receiving PDCP entity transmits the PDCP status report prior to transmission of any of its PDCP data PDUs. When the transmitting PDCP entity receives the PDCP status report, the transmitting PDCP entity cancels retransmission of the PDCP SDUs or PDUs which were indicated as received in the PDCP status report.

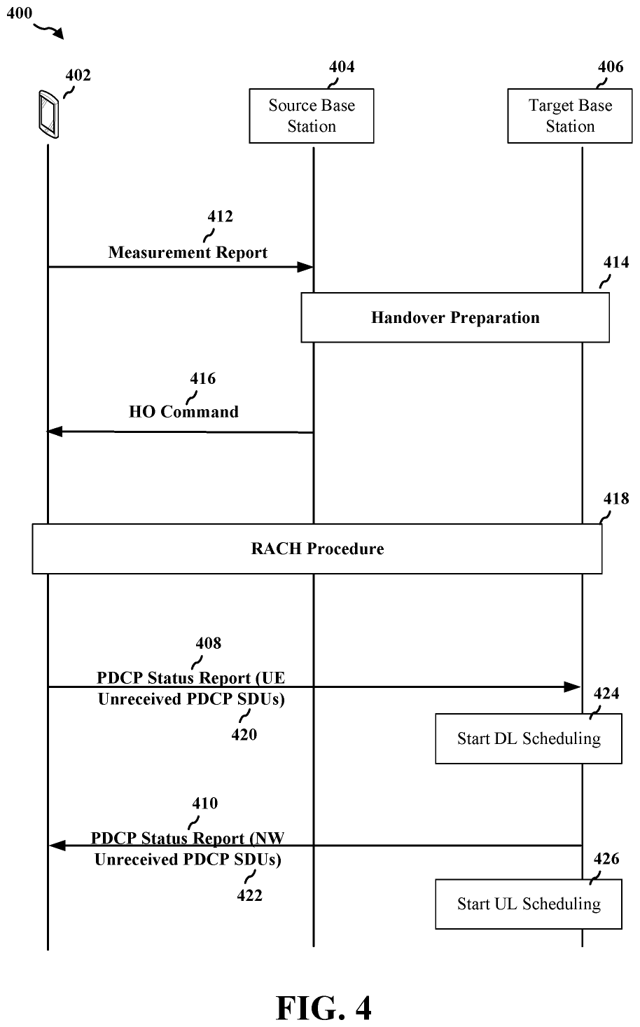

However, before the PDCP status report is received at the transmitting PDCP entity, the transmitting PDCP entity may still begin PDCP retransmissions to the receiving PDCP entity. As a result, since PDCP retransmissions are not feedback-based, duplicate retransmissions of PDCP SDUs or PDUs may still occur. To minimize duplicate retransmissions of PDCP SDUs or PDUs, the transmitting PDCP entity may first refer to the PDCP status report before performing its PDCP retransmissions. For instance, the transmitting PDCP entity may control the start timing of downlink or uplink scheduling for a UE using the PDCP status report such as described below with respect to FIG. 4.

FIG. 4 illustrates an example 400 of a call flow between a UE 402, a source base station 404 prior to a handover of the UE 402, and a target base station 406 after a handover of the UE 402. Here, source base station 404 and target base station 406 are aggregated base stations corresponding to different base stations 102/180, and UE 402 corresponds to UE 104 in FIGS. 1A and 1B. In this example, following a handover of UE 402 from source base station 404 to target base station 406, the target base station 406 may control the start timing of downlink or uplink scheduling for the UE 402 using a UE PDCP status report 408 or network (NW) PDCP status report 410 respectively. For example, the UE 402 may initially send a measurement report 412 (MR) to source base station 404, which triggers source base station 404 to communicate handover-related signaling with target base station 406 during a handover preparation procedure 414 and to provide a handover (HO) command 416 to UE 402. Following UE performance of a random access channel (RACH) procedure 418 in response to the HO command 416 to connect with target base station 406, the UE 402 may either transmit UE PDCP status report 408 to the target base station 406 indicating previously received, downlink PDCP SDUs 420, or the UE 402 may receive NW PDCP status report 410 from the target base station 406 indicating previously received, uplink PDCP SDUs 422. In response to receiving or transmitting the PDCP status report 408 or 410, respectively, the target base station 406 may begin downlink scheduling at block 424 or uplink scheduling at block 426 accordingly for unreceived PDCP SDUs but not for previously received PDCP SDUs 420, 422, thereby avoiding duplicative retransmissions of PDCP SDUs to or from UE 402.

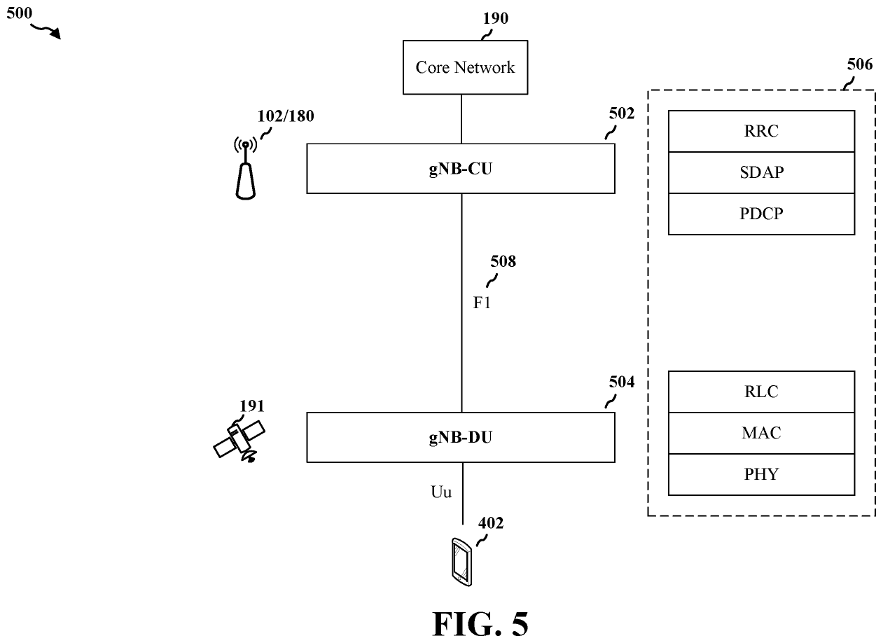

However, while an aggregated base station such as target base station 406 may maximize gains from PDCP status reports 408, 410 by beginning downlink or uplink scheduling after exchanging PDCP status reports 408, 410 with the UE 402, the same may not necessarily be said for a disaggregated base station such as disaggregated base station 181 including a functional split between CU 183 and DU 185. For instance, FIG. 5 illustrates an example 500 of a network in which a gNB-CU 502 such as CU 183 of disaggregated base station 181 in communication with core network 190, and a gNB-DU 504 such as DU 185 of disaggregated base station 181 or satellite 191, are responsible for different functional layers of a radio protocol stack 506. In particular, the functional split may be such that the gNB-CU 502 includes an RRC layer, a SDAP layer, and a PDCP layer, while the gNB-DU 504 includes a RLC layer, a MAC layer, and a PHY layer, to allow for increased fronthaul bandwidth at least in large bandwidth, massive MIMO, or cloud-RAN (C-RAN) deployments. In such functionally split architecture, downlink data may be processed at gNB-CU 502 in the RRC, SDAP, and PDCP layers before being communicated over an open, F1 interface 508 to gNB-DU 504, at which point the PDCP PDUs from gNB-CU 502 are processed in the RLC, MAC, and PHY layers of gNB-DU 504 and subsequently communicated to UE 402 over a Uu interface. Similarly, uplink data from UE 402 may be processed in the PHY, MAC, and RLC layers of gNB-DU 504 before being communicated over the F1 interface 508 to gNB-CU 502, at which point the PDCP PDUs from gNB-DU 504 are processed in the PDCP, SDAP, and RRC layers of gNB-CU 502.

Thus, when the gNB-CU 502 and gNB-DU 504 are functionally split in this manner, or in some other manner where the PDCP layer is located at the gNB-CU 502 while the MAC layer is located at the gNB-DU 504, the gNB-DU 504 may not be able to autonomously decide an efficient start time for downlink or uplink scheduling based on the PDCP status report 408, 410 in contrast to target base station 406. For instance, the gNB-DU 504 may not be informed of whether or not the PDCP status report 408 or 410 has been exchanged between UE 402 and gNB-CU 502, and the gNB-DU 504 may not attempt to derive the presence, timing, or contents of PDCP status report 408 or 410 by decoding a PDCP configuration or ascertaining gNB-CU implementation. As a result, duplicated PDCP PDU retransmissions or transmission delays may still occur when gNB-CU 502 is the receiving or transmitting PDCP entity of the PDCP status report 408 or 410 respectively.

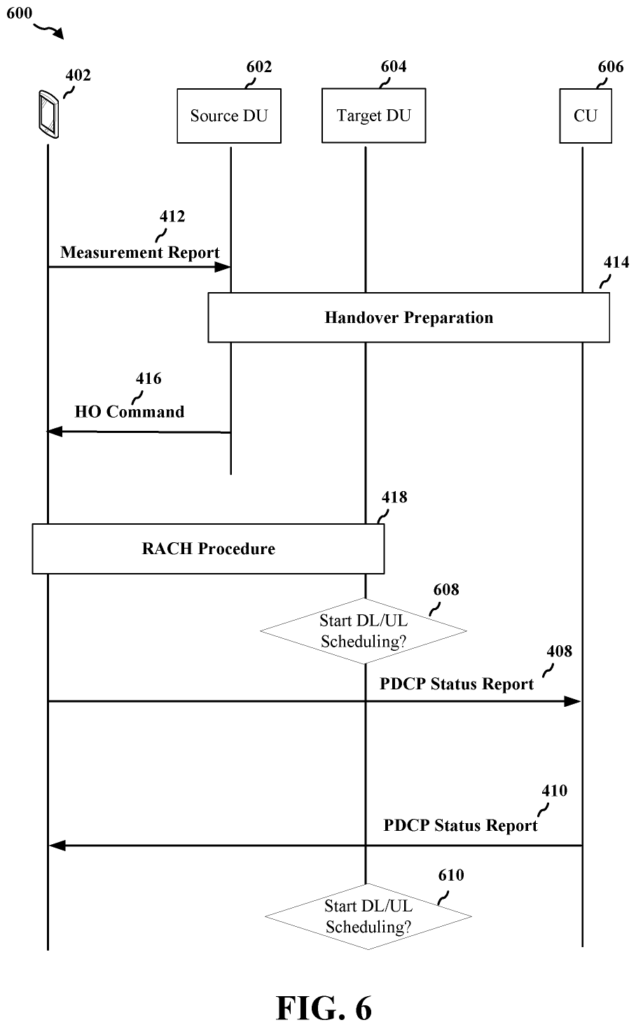

FIG. 6 illustrates an example 600 of a call flow between UE 402, a source DU 602 prior to a handover of the UE 402, a target DU 604 after a handover of the UE 402, and a CU 606 in a disaggregated base station architecture. Here, source DU 602 and target DU 604 correspond to different DUs 185 of a same disaggregated base station 181, or of different disaggregated base stations 181, in FIGS. 1A and 1B. Similar to the example 400 of FIG. 4, UE 402 may transmit measurement report 412 to the source DU 602, in response to which source DU 602 may perform handover-related signaling with target DU 604 and CU 606 during handover preparation procedure 414 and subsequently transmit HO command 416 to UE 402. UE 402 may likewise perform RACH procedure 418 in response to the HO command 416, after which UE 402 may transmit UE PDCP status report 408 to CU 606 via target DU 604 for downlink scheduling or receive NW PDCP status report 410 from CU 606 via target DU 604 for uplink scheduling. However, here unlike the example of FIG. 4 where a same device or target base station 406 receives or transmits the PDCP status report 408 or 410 and performs the downlink or uplink scheduling, in the example of FIG. 6 these operations are split between the CU 606 and target DU 604 respectively, and thus the target DU 604 does not have information regarding presence, timing, or contents of PDCP status report 408 or 410. As a result, if the target DU 604 does not take into account the PDCP status report 408 or 410 in PDCP transmissions, the target DU 604 may end up sending duplicated PDCP PDU transmissions to UE 402 or CU 606 in response to starting scheduling of downlink or uplink data prematurely at block 608. Alternatively, if the target DU 604 attempts to blindly wait until after an expected time for communication of the PDCP status report 408 or 410, the target DU 604 may end up incurring an unnecessary scheduling delay for PDCP PDU transmissions in response to starting scheduling of downlink or uplink data belatedly at block 610.

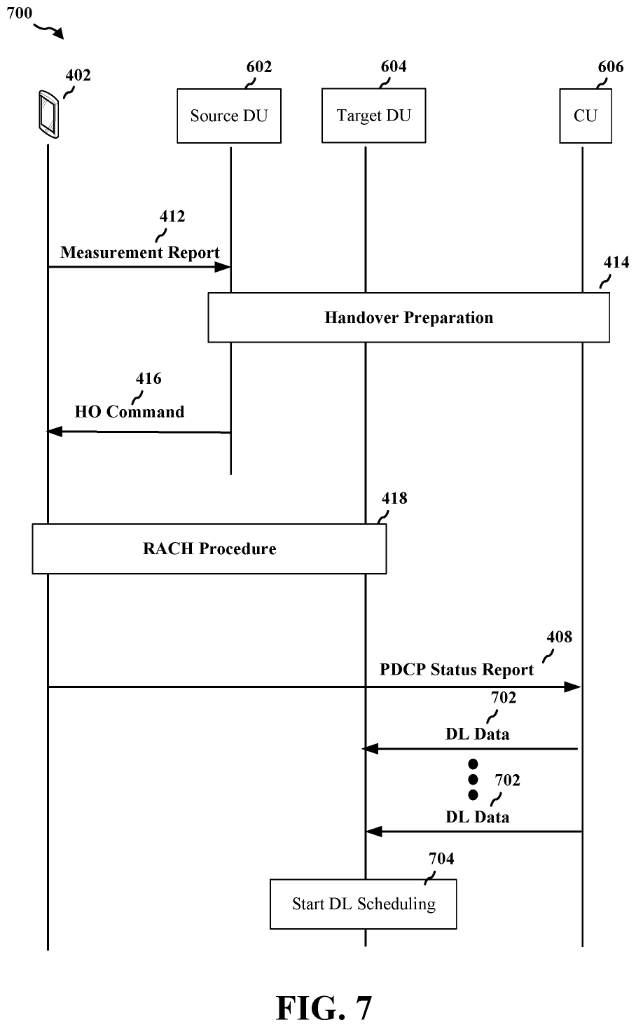

One approach to avoid duplicate, downlink PDCP PDU transmissions in functional split scenarios, where the gNB-DU 504 does not have information regarding presence, timing, or contents of PDCP status report 408 or 410, is for gNB-CU 502 to control delivery timing of downlink data to the gNB-DU 504 to coincide with reception of PDCP status report 408. For instance, FIG. 7 illustrates an example 700 of a call flow between UE 402, source DU 602 prior to a handover of the UE 402, target DU 604 after a handover of the UE 402, and CU 606, similar to example 600 of FIG. 6, but where CU 606 controls delivery timing of downlink data 702 to target DU 604 to coincide with reception of UE PDCP status report 408. In this example, CU 606 may suspend downlink data delivery to target DU 604 until after CU 606 receives PDCP status report 408 from UE 402, after which the CU 606 then begins delivering the downlink data 702 indicated as unreceived in the UE PDCP status report 408 to target DU 604. Target DU 604 may then start scheduling downlink data at block 704 in response to receiving the downlink data 702 from CU 606. In this way, duplicate retransmissions of downlink PDCP PDUs may be avoided.

However, while this approach of FIG. 7 may ostensibly resolve the unoptimized scheduling timing generally present in networks with a CU-DU split such as described with respect to FIG. 6, such approach may also lead to feeder link congestion in NTNs or regenerative architectures. For instance, NTNs may include moving cells, or cells served by gNB-CUs 502 in communication with moving satellites 191 or gNB-DUs 504. Between such NTN cells 188, handovers may be performed for numerous UEs 402 at a given time. Since such handovers may trigger PDCP retransmission to be performed for many UEs within a short period of time, controlling downlink data delivery as described with respect to FIG. 7 may cause the feeder link between the gNB-CU 502 and gNB-DU 504 to rapidly congest and consequently lead to downlink transmission delay over the service links between the gNB-DU 504 and UEs 402. Thus, since bandwidth is more limited and unoptimized downlink scheduling may be more severe in NTNs than in TNs, it would be helpful to at least further optimize downlink scheduling in functional split scenarios where the DU 185 is incorporated in satellite 191 to minimize or avoid unnecessary over-the-air transmissions.

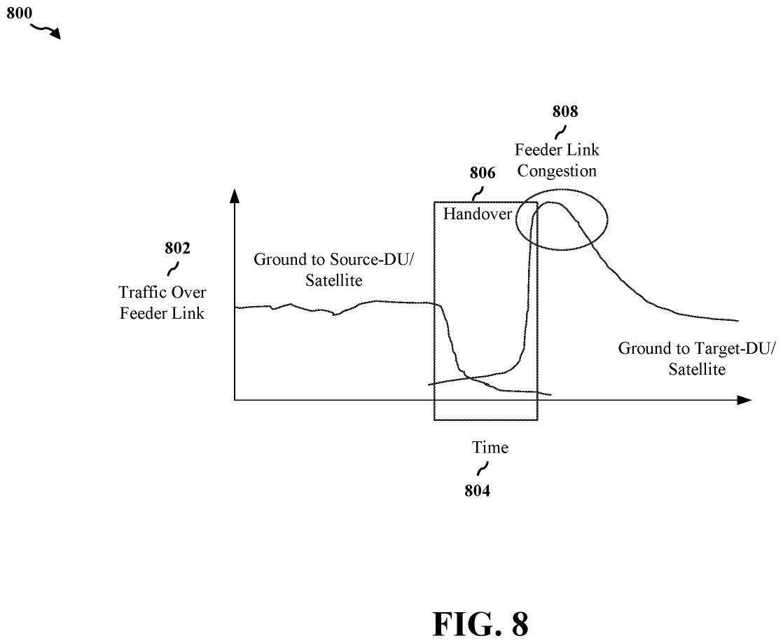

FIG. 8 illustrates an example 800 of a chart showing feeder link traffic 802 over time 804 prior to and following a handover 806 in cases where the CU 606 controls downlink data delivery to occur following reception of UE PDCP status report 408 such as described with respect to FIG. 7. Initially, traffic 802 between the CU 606 and the source DU 602 or satellite 191 may be stable until satellite movement results in handover 806, after which the CU 606 stops sending downlink data to the source DU 602 and feeder link traffic 802 at the source DU 602 decreases towards zero. During handover 806, the CU 606 may buffer its downlink data 702 until the handover 806 completes, the UE 402 successfully connects to the target DU 604 following RACH procedure 418, and the UE PDCP status report 408 is received at the CU 606. At that time, the CU 606 begins sending its buffered downlink data 702 to the target DU 604 at once, causing traffic 802 over the feeder link to exponentially increase to a peak 808 resulting in significant congestion and downlink traffic delay.

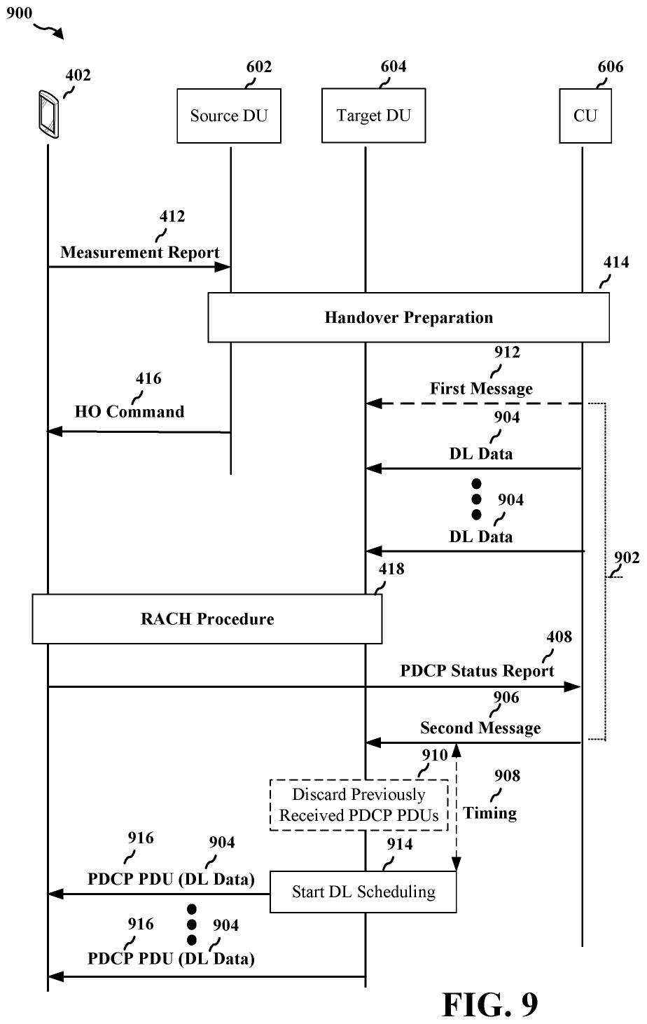

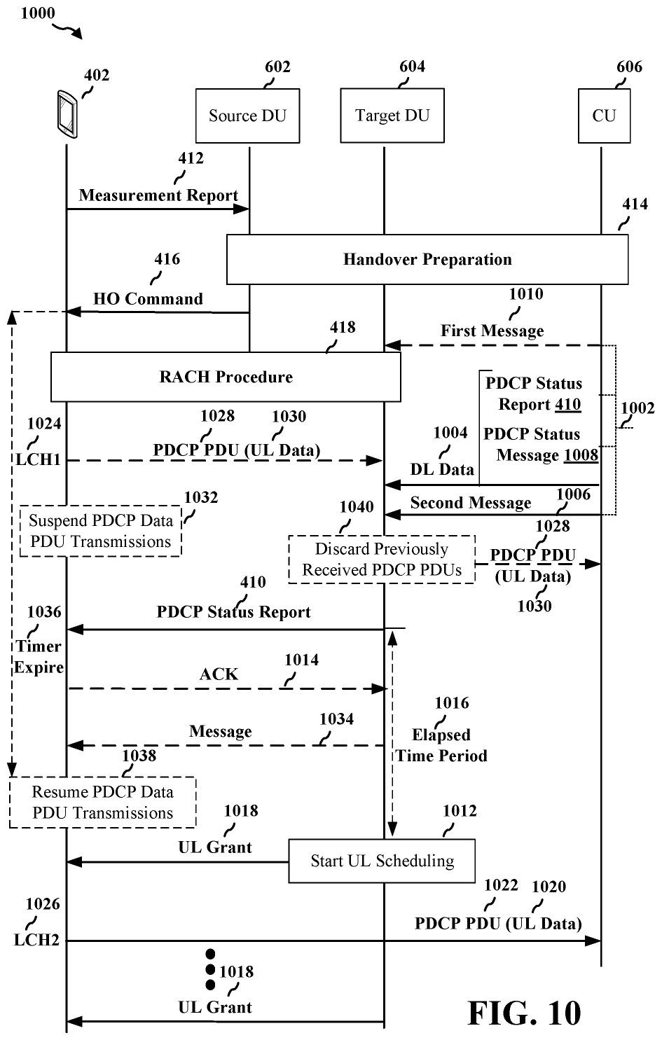

Therefore, it would be helpful to begin downlink or uplink scheduling as early as possible in CU-DU split NTN architectures including satellite-covered cells to not only avoid loss of transmission opportunities to served UEs on the downlink and uplink, but also to minimize feeder link congestion on the downlink. To these ends, aspects of the present disclosure allow CU 606 to provide a DU such as target DU 604 assistance information related to PDCP status report 408 or 410, from which assistance information the DU 604 may determine appropriate downlink or uplink scheduling start timing. In particular, FIG. 9 describes aspects relating to assistance information for downlink scheduling, while FIG. 10 describes aspects related to assistance information for uplink scheduling. In at least one of these aspects, the CU 606 may also deliver downlink data to the DU 604 before the CU 606 receives the PDCP status report 408, thereby minimizing feeder link congestion on the downlink in handovers resulting from moving satellites.

While the following Figures and their accompanying description refer to various aspects of the present disclosure in connection with a handover of UE 402 from source DU 602 to target DU 604, it should be understood that these aspects are not limited to handovers and may similarly apply to scenarios with a single DU (no handover). Thus, any reference throughout this disclosure to target DU 604 may be substituted with a DU in general. Similarly, any reference throughout this disclosure to handover-related operations that occur prior to communication of PDCP status reports 408, 410 or assistance information, such as measurement reports 412, handover preparation procedures 414, HO commands 416, and RACH procedures 418, are optional operations and thus may or may not be included in connection with these aspects. Furthermore, the aspects of the present disclosure are not limited to the context of handover of RRC connection re-establishment, and may apply to general scenarios where PDCP retransmissions are cancelled. For instance, any reference throughout this disclosure to a PDCP retransmission trigger for PDCP status report 408, 410 is not limited to handover or RRC re-establishment contexts such as PDCP re-establishment or PDCP data recovery, but may encompass other contexts where downlink or uplink PDCP retransmissions or PDCP status reports may be triggered. Additionally, references to SDU or PDU throughout the present disclosure may be interchanged in connection with its various aspects. For instance, references to PDCP PDUs may be replaced with PDCP SDUs, or vice-versa, at least in connection with the downlink aspects described with respect to FIG. 9 and the uplink aspects described with respect to FIG. 10. Lastly, while the downlink aspects of FIG. 9 and the uplink aspects of FIG. 10 are described separately, these aspects are not mutually exclusive and may be implemented in combination. As an example, DU 604 may schedule downlink data based on CU-provided assistance information related to PDCP status report 408 at one time, but schedule uplink data based on CU-provided assistance information related to PDCP status report 410 at another time.

FIG. 9 illustrates an example 900 of a call flow between UE 402, source DU 602 prior to a handover of the UE 402, target DU 604 after a handover of the UE 402, and CU 606 where the CU 606 provides assistance information 902 to target DU 604 for downlink scheduling. Using this assistance information 902, the CU 606 indicates to the target DU 604 when the DU 604 may begin scheduling downlink (DL) data 904 for the UE 402. The DU 604 suspends or refrains from performing downlink data scheduling to the UE 402 until the assistance information 902 is received, after which the DU 604 begins performing or resumes downlink data scheduling to the UE 402. Thus, the DU 604 may determine, and the CU 606 may control, the start timing for downlink data scheduling based on the assistance information 902.

In one example, the CU 606 delivers DL data 904 to DU 604 after UE handover is completed, but before the CU 606 receives PDCP status report 408 from the UE 402. The DU 604 buffers the DL data 904 received from CU 606. After the UE 402 completes its RACH procedure 418 and connects to the target DU 604, the UE 402 transmits PDCP status report 408 to the CU 606 via the target DU 604. Since the target DU 604 does not ascertain whether or not data received from UE 402 includes PDCP status report 408 (from its perspective, the PDCP status report 408 is indiscernible from other uplink data from UE 402), the target DU 604 simply routes the data to the CU 606 after performing PHY layer, MAC layer, and RLC layer processing on the data. In response to receiving the PDCP status report 408 from UE 402 via target DU 604, the CU 606 determines the unreceived downlink PDCP SDUs 420 the UE indicated in the status report, and the CU 606 provides a message 906 to target DU 604 indicating the PDCP PDUs the target DU 604 is to retransmit to the UE (the unreceived PDCP SDUs).

Message 906 is an example of assistance information 902 which CU 606 may provide for downlink data scheduling of UE 402. An example of information that may be included in message 906 is a UE identifier (UEID) associated with UE 402 for which the DU 604 is to schedule downlink data 904, a tunnel endpoint identifier (TEID) associated with a data radio bearer for the DL data 904 to be scheduled for the UE 402, information such as a bit or Boolean value which indicates whether DU 604 is to begin scheduling downlink data 904 associated with the indicated TEID to the UE 402 with the indicated UEID, a flow identifier, bearer identifier, PDCP entity identifier, RLC channel (or bearer or entity) identifier, a logical channel identifier, or a combination of any of the foregoing. For example, the CU 606 may set a bit or Boolean value in message 906 to one value such as ‘1’ or ‘true’ if the DU 604 is to begin or resume downlink data scheduling. Alternatively, the CU 606 may set the bit or Boolean value to a different value such as ‘0’ or ‘false’ if the DU 604 is to refrain from or wait to begin or resume downlink data scheduling. In either example, the message 906 may optionally further include an indication of whether the DU 604 is to perform downlink data scheduling upon reception of the message 906, or whether the DU 604 is to delay downlink data scheduling until a period of time 908 has elapsed following a time of reception of the message 906. The message 906 may also optionally indicate the period of time 908 during which the DU 604 is to delay the downlink data scheduling.

Furthermore, the message 906 may optionally indicate whether or not the DU 604 is to discard at block 910 any PDCP downlink SDUs 420 carrying downlink data 904 from the CU 606 which the UE 402 had previously received, and if so, which PDCP downlink PDUs or SDUs 420 the DU 604 is to discard prior to performing downlink data scheduling. For example, if the CU 606 determines from the PDCP status report 408 that certain PDCP DL PDUs were already received by UE 402, but that the CU 606 had already transmitted to the DU 604 duplicates of these PDCP DL PDUs including DL data 904 prior to providing message 906, the CU 606 may indicate in message 906 that the DU 604 is to discard or delete these duplicate PDCP PDUs from its memory at block 910 without transmitting them to the UE 402 during downlink scheduling. Alternatively, if the CU 606 determines from the PDCP status report 408 that no prior PDCP DL PDUs were successfully received at the UE 402, or otherwise that the CU 606 had not transmitted to the DU 604 any duplicate PDCP PDUs prior to providing message 906, the CU 606 may indicate in message 906 that the DU 604 is not to discard any of its received PDCP PDUs from memory and may proceed to transmit the received downlink data 904 accordingly during downlink scheduling.

In one example, the message 906 may be provided via one or more frames or information elements which, although configured for other purposes than assistance information 902, the CU 606 may reuse as assistance information 902 to assist in downlink data scheduling. For instance, the CU 606 may reuse one or more fields of a DL user data PDU Type 0 frame or information element, generally applied for detecting lost NR user plane (NR-U) interface packets, for the additional purpose of indicating which buffered packets of DL data 904 the DU 604 can discard at block 910 and which packets the DU 604 can send during downlink data scheduling. The CU 606 may re-use one or more field(s) of this frame, or of another frame or information element associated with the PDCP layer, to indicate the DU 604 to discard at block 910 previously received, PDCP PDUs. For instance, the CU 606 may indicate the DU 604 to discard PDCP data PDUs indicated as previously received by UE 402 but not to discard PDCP control PDUs. The CU 606 may also include sequence numbers of the discardable PDUs in re-used field(s) of a frame or information element, such as PDCP sequence numbers or NR-U sequence numbers, to indicate which downlink PDUs are to be discarded at the DU 604. In response to receiving this indication in message 906 to discard certain packets of downlink data 904, the DU 604 may ascertain which of the remainder of downlink data 904 may be transmitted to the UE 402, and the DU 604 may proceed to transmit this data during downlink scheduling. For instance, the DU 604 may proceed to schedule un-discarded data corresponding to the unreceived PDCP SDUs 420 indicated in the PDCP status report 408 from the UE 402.

In another example, rather than providing message 906 via re-used information element(s) such as described in the previous example, the message 906 may be provided via one or more dedicated information elements for indicating to the target DU 604 when the DU 604 may begin scheduling DL data for the UE 402. For instance, CU 606 may transmit an RRC message via an F1 interface between CU 606 and target DU 604, such as an F1 Application Protocol (F1-AP) interface or an F1-user plane (F1-U) interface, including a bit or some other indication of an instruction to the DU to begin downlink scheduling. Alternatively, the message 906 may be transmitted via a different interface between CU 606 and target DU 604, or in some other manner. Similar to the previous example of re-used information element(s), the message 906 may indicate the DU 604 to discard, at block 910, previously received PDCP data PDUs that the UE 402 indicated in the PDCP status report 408, but not to discard PDCP control PDUs, using sequence numbers of the discardable PDUs such as PDCP sequence numbers or NR-U sequence numbers. However, in this example, different information element(s) or field(s) may be included in the message 906 for this purpose rather than re-used field(s). For instance, the message 906 may include a field containing a bitmap indicating the PDCP DL PDUs that the DU 604 is to discard at block 910 prior to downlink scheduling, or the non-discarded PDUs the DU 604 is to send to the UE 402 during downlink scheduling. The bitmap may be in a similar format to a bitmap in PDCP status report 408 indicating the UE reception status of PDCP DL PDUs, or a different format. Alternatively, the message 906 may include a field containing a range of PDCP DL sequence numbers or other cumulative information of packets that the DU 604 is to discard prior to downlink scheduling, or the non-discarded PDUs the DU 604 is to send to the UE 402 during downlink scheduling. This cumulative information may be in a similar format to an SN range of PDUs in an RLC status report indicating the UE acknowledgment status of RLC SDUs or PDUs, or in a different format.

Prior to providing downlink data 904 to the DU 604, the CU 606 may optionally provide a message 912 to the target DU 604 indicating to expect message 906 from CU 606 prior to scheduling downlink data for UE 402. This message 912 may thus also be an example of assistance information 902 which CU 606 may provide to DU 604 for downlink data scheduling of UE 402. In one example, message 912 may be an additional message to messages generally exchanged during handover preparation, such as a separate message to a handover request, handover acknowledgment, or the like communicated during handover preparation procedure 414. In other examples, message 912 may be transmitted after the handover preparation procedure 414, such as illustrated in the example of FIG. 9, before the handover preparation procedure 414, or independent of a handover preparation procedure (if a handover is not present). In a further example, rather than sending message 912 as a separate message to those exchanged during handover preparation such as previously described, message 912 may be integrated in a message exchanged during handover preparation. For instance, the CU 606 may include the information of message 912, or the indication to expect message 906, within a handover request, acknowledgement, or other message exchanged during handover preparation procedure 414. In any of these examples, message 912 may be an RRC message communicated from the CU 606 to the target DU 604 via an F1 interface, such as an F1-AP interface or an F1-user plane interface, or the information of message 912 may be included in such RRC message.

Similar information to that of message 906 may be included in message 912. For instance, an example of information that may be included in message 912 is a UEID associated with UE 402 for which the DU 604 is to schedule downlink data 904, a TEID associated with a data radio bearer for the buffered, DL data 904 to be scheduled for the UE 402, information such as a bit or Boolean value which indicates whether DU 604 is to expect message 906 from the CU 606 prior to scheduling the downlink data 904 for the indicated UE, a flow identifier, bearer identifier, PDCP entity identifier, RLC channel (or bearer or entity) identifier, a logical channel identifier, or a combination of any of the foregoing. For example, the CU 606 may set the bit or Boolean value in message 906 to one value such as ‘1’ or ‘true’ if message 906 is to be expected or sent from the CU 606 and thus that DU 604 is to suspend downlink data scheduling until it receives further instruction from the CU 606. Alternatively, the CU 606 may set the bit or Boolean value to a different value such as ‘0’ or ‘false’ if message 906 is not to be expected or sent from the CU 606 and thus that the DU 604 is to perform downlink data scheduling upon receipt of DL data 904 from the CU 606 without suspension. Thus, based on the information contained, message 912 may indicate to DU 604 to suspend scheduling of downlink data 904 associated with the indicated TEID for the UE 402 with the indicated UEID until after the message 906 is received.

Message 912 is also an optional message that CU 606 may send to the DU 604 if the DU 604 does not have the capability to autonomously expect to receive message 906 after a handover or otherwise prior to performing downlink data scheduling. For instance, CU 606 may transmit message 912 to target DU 604 in cases where the CU 606 does not receive an indication from DU 604 that DU 604 is capable of autonomously refraining from sending downlink data 904 to the UE 402 before receiving message 906 from the CU 606 to begin or resume the DL scheduling. Therefore, to prevent the DU 604 from by default performing inefficient DL scheduling as a result of this lack of capability, the CU 606 may send message 912 informing the DU 604 to wait with performing the scheduling. For instance, in response to receiving message 912, the DU 604 may avoid sending duplicate PDUs of downlink data 904 to the UE 402 prior to the CU 606 receiving PDCP status report 408 including previously received PDCP SDUs 420, such as originally described with respect to FIG. 6 at block 608. Similarly, in response to receiving message 912, the DU 604 may avoid delaying to an unnecessary extent the sending of downlink data 904 until after expiration of a DU timer which is blind to the timing of the PDCP status report 408, such as originally described with respect to FIG. 6 at block 610. Instead, the DU 604 may hold off on sending the downlink data 904 to UE 402 in response to message 912 until after the DU 604 receives message 906 from the CU 606, thereby more efficiently minimizing or preventing duplicate PDCP SDU transmissions and unnecessarily extended scheduling delays. On the other hand, if the DU 604 does indicate to CU 606 in a capability information message or in some other manner that the DU 604 is configured to autonomously refrain from sending downlink data 904 to the UE 402 until after message 906 is received, or otherwise that the DU 604 has the capability to expect to receive message 906 before scheduling DL data, then the CU 606 may omit sending or refrain from sending message 912 to DU 604. Thus, message 912 is an optional message from CU based on DU capability.

After the CU 606 provides assistance information 902 including message 906 and optionally message 912 to the target DU 604, the target DU 604 then begins scheduling downlink data at block 914 based on the assistance information 902. For instance, the target DU 604 performs RLC layer processing, MAC layer processing, and PHY layer processing to PDCP PDUs 916 including the previously buffered, downlink data 904 which are indicated in message 906 as unreceived at the UE 402, and the target DU 604 sends the processed downlink data in the PDCP PDUs 916 to the UE 402. Duplicate data indicated in the message 906 as previously received at the UE 402 on the other hand are discarded at block 910 and thus excluded from processing during downlink scheduling and transmission. In this way, the target DU 604 may be informed via at least message 906 of appropriate downlink scheduling timing to avoid duplicate retransmissions of previously received PDCP SDUs 420 at the UE 402. The message 906 may indicate to target DU 604 which PDCP PDUs the target DU 604 is to send to the UE 402, and which PDCP PDUs the target DU is to discard at block 910. Moreover, if the CU 606 and DU 604 are in an NTN, this approach may serve to reduce the feeder link congestion illustrated at peak 808 in FIG. 8, since in contrast to the approach of FIG. 7, here the CU 606 does not provide the downlink data 904 at once to the target DU 604 following reception of the PDCP status report 408.

Thus, this aspect of the present disclosure described with respect to FIG. 9 allows a functionally split network to prevent duplicate retransmissions of previously received, downlink PDCP SDUs 420 as well as inefficient DL scheduling. For instance, by allowing the CU 606 to provide assistance information 902 including message 906 to the DU 604 indicating the DU to wait until after the PDCP status report 408 is received before sending downlink PDCP PDUs to the UE 402, duplication of PDCP SDU transmissions and unnecessarily extended scheduling delays may be minimized or avoided. Moreover, by allowing the CU 606 to optionally provide assistance information 902 including message 912 to the DU 604, which indicates the DU 604 to expect subsequent reception of message 906 prior to performing downlink scheduling, the likelihood of the DU performing inefficient scheduling based on differences in capability between the CU 606 and DU 604 may be similarly minimized or avoided.

Furthermore, this aspect of the present disclosure described with respect to FIG. 9 allows a functionally split NTN to avoid the feeder link congestion illustrated in FIG. 8. For example, the illustrated chart in FIG. 8 would be modified in this aspect such that the peak 808 of feeder link traffic 802 would be reduced and the feeder link traffic 802 during the handover 806 increased. This change would occur as a result of downlink data 904 being sent to the target DU 604 during the handover 806 and prior to PDCP status report reception, instead of afterwards as previously described with respect to FIG. 7. Thus, this aspect of the present disclosure also causes the feeder link traffic 802 to be stabilized at a manageable level throughout the handover process.

FIG. 10 illustrates an example 1000 of a call flow between UE 402, source DU 602 prior to a handover of the UE 402, target DU 604 after a handover of the UE 402, and CU 606 where the CU 606 provides assistance information 1002 to target DU 604 for uplink scheduling. Using this assistance information 1002, the CU 606 indicates to the target DU 604 whether or not its downlink data 1004, which generally contains information relevant to uplink scheduling, includes PDCP status report 410 of the CU 606, and thus when the DU 604 may begin scheduling uplink (UL) data from the UE 402. The DU 604 suspends or refrains from performing uplink data scheduling for the UE 402 until the assistance information 1002 is received, after which the DU 604 begins performing or resume uplink data scheduling for the UE 402. If the UE 402 happens to send duplicates of previously received uplink PDCP SDUs 422 to DU 604 in advance of receiving PDCP status report 410 from CU 606, such as in cases where the UE 402 is configured with multiple logical channels for uplink transmissions associated with different priorities, the DU 604 may also discard these uplink PDCP SDUs in response to assistance information 1002. Alternatively, the UE 402 may itself suspend or refrain from performing uplink data transmissions following a handover, RRC re-establishment procedure, or other PDCP retransmission trigger until a time after PDCP status report 410 is received. Thus, the DU 604 may determine, and the CU 606 may control, the start timing for uplink data scheduling based on the assistance information 1002, in some cases with further assistance from UE 402.

In one example, the CU 606 prepares PDCP status report 410 indicating one or more unreceived PDCP uplink SDUs 422 from the UE 402. After handover is completed, the CU 606 delivers DL data 1004 including PDCP status report 410 to the target DU 604 for the DU 604 to provide to the UE 402 and for the DU 604 to consider before performing uplink scheduling. The DL data 1004 may be delivered to the DU 604 before the UE 402 performs RACH procedure 418 to connect to the target DU 604, or after the RACH procedure 418 such as illustrated in the example of FIG. 10. However, since the contents of the PDCP status report 410 are transparent to the target DU 604, the CU 606 also provides message 1006 indicating the presence of PDCP status report 410 in the DL data 1004. For instance, the CU 606 may provide an indication in message 1006, such as a bit or Boolean value, of whether or not the DL data 1004 includes the PDCP status report 410. In response to this indication, the target DU 604 may ascertain the timing of the PDCP status report 410 for beginning uplink data scheduling, as well as the unreceived PDCP uplink SDUs 422 from UE 402 indicated in the PDCP status report 410. The CU 606 may attach this indication to a message containing the PDCP status report 410 (message 1006 may include the PDCP status report 410), or the CU 606 may send the indication separately from the PDCP status report 410 such as illustrated by message 1006 in the example of FIG. 10. Thus, the assistance information 1002 in this example may be the message 1006 or indication accompanying the PDCP status report 410, although the assistance information 1002 may be the PDCP status report 410 itself in other examples.

In another example, rather than providing an indication of the presence of PDCP status report 410 so that the target DU 604 may determine PDCP status report timing and unreceived PDCP uplink SDUs 422 from the PDCP status report 410 itself, the CU 606 may provide a message 1008 to target DU 604 separate from the PDCP status report 410 indicating the unreceived PDCP uplink SDUs 422. The message 1008 may indicate the unreceived PDUs using one or more re-used information elements or information element fields, or one or more dedicated information elements or information element fields for this purpose, in a similar manner to that described with respect to FIG. 9. Moreover, if the message 1008 is included in downlink data 1004 and is transparent to the target DU 604 similar to the PDCP status report 410, such as illustrated in the example of FIG. 10, the CU 606 may also provide an indication via message 1006 such as a bit or Boolean value of whether or not the DL data 1004 includes the message 1008. The CU 606 may attach this indication to the message 1008 indicating the unreceived PDUs (message 1006 may include message 1008), or the CU may send the indication separately from the message 1008 such as illustrated by message 1006 in the example of FIG. 10. Thus, the assistance information 1002 in this example may be the message 1008 or the indication or message 1006 accompanying the message 1008.

Furthermore, prior to providing downlink data 1004 to the DU 604, the CU 606 may optionally provide a message 1010 to the target DU 604 (similar to message 912 of FIG. 9) indicating to expect message 1006, PDCP status report 410, message 1008, or any combination of these, from CU 606 prior to scheduling uplink data. This message 1010 may thus also be an example of assistance information 1002 for uplink data scheduling of UE 402. Message 1010 may have a format, content, and purpose which is the same or similar to that of message 912. For example, message 1010 may be an additional, separate message to messages generally exchanged during handover preparation procedure 414, message 1010 may be transmitted before handover preparation procedure 414, after handover preparation procedure 414 such as illustrated in the example of FIG. 10, or independent of a handover preparation procedure (if a handover is not present), or message 1010 may be integrated within a handover request, acknowledgement, or other message exchanged during handover preparation. Likewise, similar to message 912, message 1010 may be an optional message that CU 606 may send to the DU 604 if the DU 604 does not have the capability to autonomously expect to receive message 1006, PDCP status report 410, message 1008, or any combination of these after a handover or otherwise prior to performing uplink data scheduling. Thus, message 1010 may likewise prevent the DU 604 from by default performing the inefficient UL scheduling originally described with respect to FIG. 6 at block 608 or 610 as a result of such lack of capability.

After the CU 606 provides assistance information 1002 including for example message 1006 and optionally message 1010 to the target DU 604, the target DU 604 may decode the downlink data 1004 for the PDCP status report 410 or message 1008 to determine the PDCP status report timing as well as the unreceived PDCP uplink SDUs 422 at the CU 606, and the DU 604 may subsequently begin uplink scheduling at block 1012 for the unreceived SDUs of the UE 402. For instance, the DU 604 may begin uplink scheduling at block 1012 immediately after the target DU 604 sends the PDCP status report 410 to the UE 402 following completion of the RACH procedure 418, after receiving an acknowledgment 1014 from the UE 402 such as a HARQ ACK or a RLC layer acknowledgment of the PDCP status report 410, or after a period of time 1016 has elapsed since transmission of the PDCP status report 410 to the UE 402. By controlling the timing of uplink (UL) scheduling to occur after transmission, acknowledgement, or expected reception of the PDCP status report 410, the DU 604 may send uplink grants 1018 for uplink data 1020 in retransmissions of unduplicated PDCP PDUs 1022 with minimal scheduling delay.

Thus, this aspect of the present disclosure described with respect to FIG. 10 allows a functionally split network to minimize duplicate retransmissions of previously received, uplink PDCP SDUs 422 as well as inefficient UL scheduling. For instance, by allowing the CU 606 to provide assistance information 1002 to the DU 604 indicating the DU to wait until after the PDCP status report 410 is transmitted, acknowledged, or expected to be received at the UE 402 before scheduling uplink PDCP PDUs from the UE 402, duplication of PDCP SDU transmissions and unnecessarily extended scheduling delays may be minimized or avoided. Moreover, by allowing the CU 606 to optionally provide message 1010 to the DU 604, which indicates the DU 604 to expect subsequent reception of message 1006, PDCP status report 410, message 1008, or a combination of these prior to performing uplink scheduling, the likelihood of the DU 604 performing inefficient scheduling based on differences in capability between the CU 606 and DU 604 may be similarly minimized or avoided.

However, notwithstanding the efficient UL scheduling which the aforementioned aspect described with respect to FIG. 10 provides, in some cases the UE 402 may still send duplicate or previously received, uplink PDCP SDUs 422 before receiving PDCP status report 410. This behavior may occur for example in scenarios where the UE 402 communicates with the CU 606 via the DU 604 using multiple data radio bearers or logical channels 1024, 1026 having different priorities or priority levels, in contrast to scenarios having single data radio bearer configurations. For instance, in a single data radio bearer configuration, the DU 604 may suspend uplink scheduling until after the CU 606 provides assistance information 1002 such as previously described with respect to FIG. 10, so the UE 402 does not have any grants in response to which the UE may send duplicate retransmissions. However, in multiple data radio bearer configurations with different priorities, the DU 604 may determine to send an uplink grant for a high priority data bearer or logical channel such as logical channel 1024, before the DU 604 receives from CU 606 the PDCP status report 410 for a low priority data bearer or logical channel such as logical channel 1026, in attempt to avoid delays in scheduling the high priority data. In response to receiving the uplink grant to send data associated with the high priority data bearer, the UE 402 may proceed to place the high priority data in a transport block for transmission to DU 604. Yet, if the transport block still has sufficient space remaining for additional data after including the high priority data, the UE 402 may proceed to include some data associated with the low priority data bearer in this remaining space. This is because UEs are generally configured to not cancel PDCP retransmissions, even if the PDCP retransmissions include previously received uplink PDUs, so long as an uplink grant provides sufficient space to accommodate uplink data. Consequently, if the UE 402 sends this transport block containing the high and low priority data prior to the CU 606 preparing the PDCP status repot 410 or transmitting the PDCP status report 410 to UE 402, the UE 402 may end up sending duplicate PDCP SDUs to those already received at the CU 606. For instance, the UE 402 may send over logical channel 1024 (the high priority channel) a PDCP PDU 1028 including uplink data 1030 which the CU 606 previously received in uplink PDCP SDUs 422 (low priority channel data).

In one example approach to prevent UE 402 from sending duplicate transmissions prior to reception of PDCP status report 410 in the aforementioned or other scenarios, the UE 402 may temporarily suspend PDCP data PDU transmissions after PDCP retransmissions are triggered. For instance, when PDCP retransmissions are triggered in response to PDCP re-establishment, data recovery, or some other PDCP retransmission trigger, the UE 402 at block 1032 may suspend its uplink transmissions until it obtains a message 1034 from the DU 604 or CU 606, or until a UE timer 1036 expires, either of which trigger the UE 402 to resume PDCP data transmissions at block 1038 for a specific data radio bearer or logical channel. In the example where message 1034 triggers the UE 402 to resume uplink transmissions at block 1038 or indicates the UE to cease suspending its PDCP data PDU transmissions, the message 1034 may be an RRC message, a PDCP control PDU, a RLC PDU, a MAC-CE, or a layer 1 message such as DCI. In the case of the message 1034 being an RLC PDU, the information in the message 1034 indicating the UE 402 to resume transmissions at block 1038 or to stop suspension may be included in a RLC control PDU or in a header of an RLC data PDU. The CU 606 or DU 604 may send this message 1034 to the UE 402 after the UE 402 receives the PDCP status report 410. In the example where expiration of UE timer 1036 triggers the UE 402 to resume uplink transmissions at block 1038, the DU 604 or CU 606 may configure the UE timer 1036 to start counting in response to the PDCP re-establishment, PDCP data recovery, or other PDCP retransmission trigger, such as in response to UE receiving HO command 416 from DU 604. The DU 604 or CU 606 may also configure the UE timer 1036 to elapse at a time after the PDCP status report 410 is expected to be received at UE 402.

Thus, this example aspect of the present disclosure described with respect to FIG. 10 allows a functionally split NTN to prevent the CU 606 and the DU 604 from receiving duplicate PDCP PDUs from UE 402 prior to UE reception of PDCP status report 410. For instance, in deployments where DU 604 corresponds to satellite 191, this aspect allows the UE 402 to suspend sending of duplicate PDCP PDU transmissions over a service link to the DU 604, which in turn allows the DU 604 to avoid performing PHY, MAC, and RLC layer processing and subsequently forwarding these processed, duplicate PDCP PDU transmissions over a feeder link to the CU 606. For example, the UE 402 may refrain from sending PDCP PDU 1028 including uplink data 1030 which the CU 606 previously received in uplink PDCP SDUs 422. As a result, the network may mitigate duplicate transmissions over both the service link and feeder link prior to UE reception of PDCP status report 410, and optionally in the case of a handover after performance of the RACH procedure with the target DU 604.

In another example approach to address UE 402 sending duplicate transmissions prior to reception of PDCP status report 410, the UE 402 does not suspend its uplink transmissions at block 1032; instead, the DU 604 selects which PDCP PDUs of the UE 402 may be delivered to the CU 606 without UE involvement. This approach may be efficient for example in cases where UE 402 does not have the capability to autonomously suspend and resume PDCP data PDU transmissions, since duplicate transmissions to CU 606 may still be mitigated without modifying UE behavior. For instance, after the UE 402 sends its PDCP data PDUs to the DU 604, such as PDCP PDU 1028 or other low priority PDUs occupying remaining space in a transport block containing high priority PDUs, the DU 604 does not immediately process and forward these packets to the CU 606. Instead, the DU 604 buffers the received PDUs in its memory at least until the DU 604 receives assistance information 1002 such as message 1006 from the CU 606. Once the DU 604 has determined from message 1006 that the DU 604 has received PDCP status report 410 or message 1008 from the CU 606, the DU determines from this information which uplink PDUs the CU 606 has previously received. For example, before the DU 604 performs PHY, MAC, and RLC layer processing and subsequently forwards the processed PDCP status report 410 to the UE 402, the DU 604 may inspect the contents of the PDCP status report 410 provided by the CU 606 to obtain the unreceived PDCP PDU identifiers. Alternatively, rather than decoding the PDCP status report 410, the DU 604 may identify the unreceived uplink PDCP PDUs at the CU 606 from indicated reception statuses of uplink data packets provided in a separate information element or message 1008 than the PDCP status report 410, which the CU 606 may communicate to the DU 604 via the F1 interface so that the PDCP status report 410 remains transparent to the DU 604. After identifying the identifiers of the previously received PDUs at the CU 606, the DU 604 at block 1040 selects to discard the received PDCP PDUs from the UE 402 that match the previously received PDUs at the CU 606 (the duplicate transmissions), and the DU 604 transmits to the CU 606 the other PDCP PDUs that were not previously received at the CU 606 (the non-duplicated retransmissions). For instance, if PDCP PDU 1028 is determined at block 1040 to include uplink data 1030 that was not in previously received, uplink PDCP SDUs 422 from UE 402, the DU 604 may process and forward the PDCP PDU 1028 to the CU 606; otherwise, the DU 604 may delete the PDCP PDU 1028 from its memory.

Thus, this example aspect of the present disclosure described with respect to FIG. 10 allows a functionally split NTN to prevent the CU 606, without UE involvement, from receiving duplicate PDCP PDUs from UE 402 prior to UE reception of PDCP status report 410. For instance, in deployments where DU 604 corresponds to satellite 191, this aspect allows the DU 604 to avoid processing and forwarding duplicate PDCP PDU transmissions over a feeder link to the CU 606, and the UE 402 to be unrestricted from sending duplicate transmissions over the service link to the DU 604. For example, the DU 604 may still receive from UE 402, but may refrain from sending to CU 606, PDCP PDU 1028 including uplink data 1030 which the CU 606 previously received in uplink PDCP SDUs 422. As a result, the network may mitigate duplicate transmissions over the feeder link prior to UE reception of PDCP status report 410, and optionally in the case of a handover after performance of the RACH procedure with the target DU 604, without modifying UE behavior.

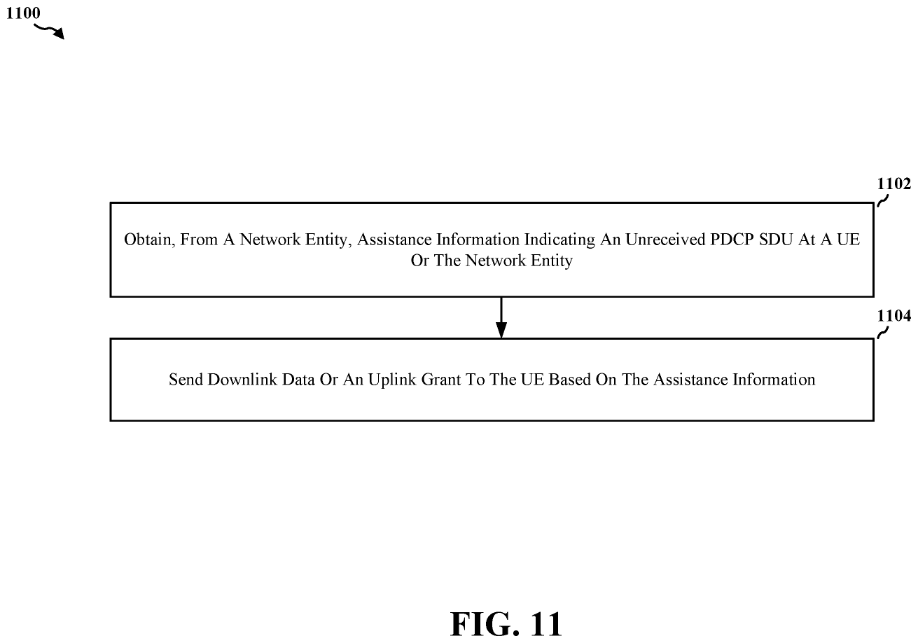

FIG. 11 is a flowchart 1100 of an example method or process for wireless communication performable at a network entity which performs enhanced downlink and uplink scheduling based on assistance information related to PDCP status reports. The method may be performed by a first network entity such as a DU, such as DU 185, first wireless device 310 or second wireless device 350, gNB-DU 504, the target DU 604, the apparatus 1702, or its components as described herein. The first network entity may be in communication with a UE, such as UE 104, 402, and with a second network entity such as a CU, such as CU 183, gNB-CU 502, CU 606. In some examples, the DU is in a satellite, the CU is in a ground station, and the DU and CU are part of a NTN.

In some examples, in block 1102, the first network entity obtains, from the second network entity, assistance information indicating an unreceived PDCP SDU at a UE or the second network entity. For example, block 1102 may be performed by assistance information component 1740. For instance, referring to the Figures, DU 604 or assistance information component 1740 may receive, from CU 606, assistance information 902, 1002 indicating unreceived downlink PDCP SDUs 420 at UE 402 or unreceived uplink PDCP SDUs 422 at CU 606 respectively. For example, on the downlink, CU 606 may provide message 906 to DU 604 indicating the PDCP PDUs or unreceived PDCP SDUs 420 the DU 604 is to retransmit to the UE. Similarly, on the uplink, CU 606 may provide message 1006 indicating the presence of PDCP status report 410, in response to which indication the DU 604 may ascertain the unreceived PDCP uplink SDUs 422 from UE 402 indicated in the PDCP status report 410.

In some examples, in block 1104, the first network entity sends downlink data or an uplink grant to the UE based on the assistance information. For example, block 1104 may be performed by data component 1742. For instance, referring to the Figures, DU 604 or data component 1742 may transmit, to UE 402, DL data 904 or UL grant 1018 based on assistance information 902, 1002 respectively. For example, on the downlink, DU 604 may perform RLC layer processing, MAC layer processing, and PHY layer processing to PDCP PDUs 916 including previously buffered, downlink data 904 which are indicated in assistance information 902 as unreceived at the UE 402, and the DU 604 may send the processed downlink data in the PDCP PDUs 916 to the UE 402. Duplicate data indicated in the assistance information as previously received at the UE 402 on the other hand are discarded at block 910 and thus excluded from processing during downlink scheduling and transmission. In this way, the DU 604 may be informed via assistance information 902 of appropriate downlink scheduling timing to avoid duplicate retransmissions of previously received PDCP SDUs 420 at the UE 402. Similarly, on the uplink, after the CU 606 provides assistance information 1002 to DU 604, the DU 604 may determine the unreceived PDCP uplink SDUs 422 at the CU 606, and the DU 604 may subsequently begin uplink scheduling at block 1012 for the unreceived SDUs of the UE 402. By controlling the timing of UL scheduling to occur after transmission, acknowledgement, or expected reception of the PDCP status report 410, the DU 604 may send uplink grants 1018 for uplink data 1020 in retransmissions of unduplicated PDCP PDUs 1022 with minimal scheduling delay.

In some examples, the downlink data or the uplink grant is for at least one logical channel of a plurality of logical channels configured for the UE. For instance, referring to the Figures, in multiple data radio bearer configurations with different priorities, the DU 604 may determine to send an uplink grant for a high priority data bearer or logical channel such as logical channel 1024, before the DU 604 receives from CU 606 the PDCP status report 410 for a low priority data bearer or logical channel such as logical channel 1026, in attempt to avoid delays in scheduling the high priority data.

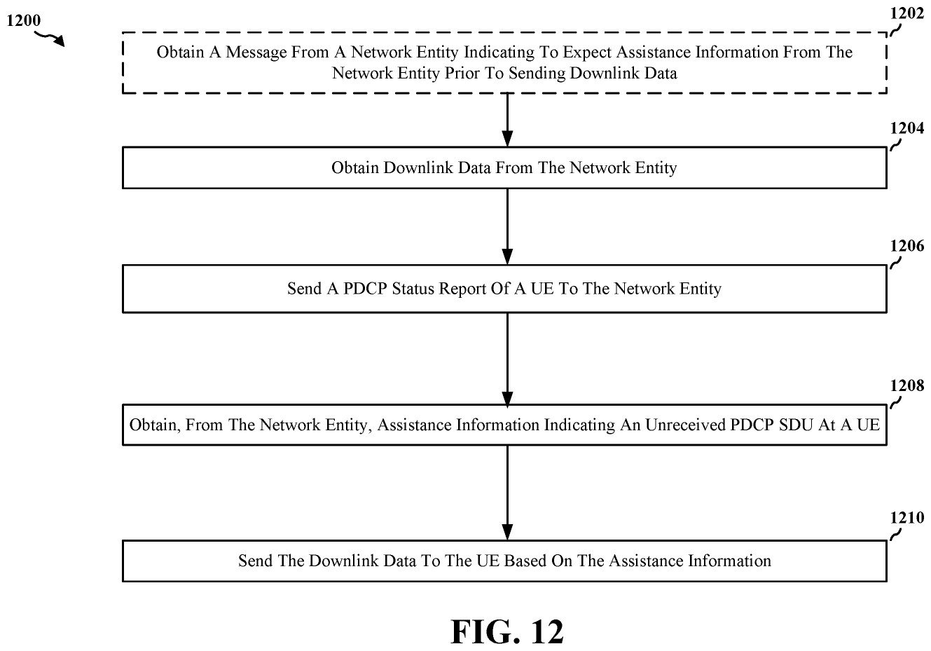

FIG. 12 is a flowchart 1200 of an example method or process for wireless communication performable at a network entity which performs enhanced downlink scheduling based on assistance information related to PDCP status reports. The method may be performed by a first network entity such as a DU, such as DU 185, first wireless device 310 or second wireless device 350, gNB-DU 504, the target DU 604, the apparatus 1702, or its components as described herein. The first network entity may be in communication with a UE, such as UE 104, 402, and with a second network entity such as a CU, such as CU 183, gNB-CU 502, CU 606. In some examples, the DU is in a satellite, the CU is in a ground station, and the DU and CU are part of a NTN. Optional aspects are illustrated in dashed lines.

In some examples, in block 1202, the first network entity obtains a message from the second network entity indicating to expect assistance information from the second network entity prior to sending downlink data to the UE. For example, block 1202 may be performed by assistance information component 1740. For instance, referring to the Figures, DU 604 or assistance information component 1740 may receive message 912 from CU 606 indicating to expect message 906 from CU 606 prior to scheduling downlink data at block 914. In some examples, the message includes at least one of a UE identifier associated with the UE, a TEID associated with the downlink data, a flow identifier associated with the downlink data, a bearer identifier associated with the downlink data, a PDCP entity identifier associated with the downlink data, a RLC channel identifier associated with the downlink data, a RLC bearer identifier associated with the downlink data, a RLC entity identifier associated with the downlink data, or a logical channel identifier associated with the downlink data. For instance, referring to the Figures, message 912 may include a UEID associated with UE 402, a TEID associated with DL data 904 or a logical channel or data radio bearer for DL data 904, or a flow identifier, bearer identifier, PDCP entity identifier, RLC channel (or bearer or entity) identifier, a logical channel identifier, or a combination of any of the foregoing associated with DL data 904.

In some examples, in block 1204, the first network entity obtains downlink data from the second network entity prior to obtaining assistance information. For example, block 1204 may be performed by data component 1742. For instance, referring to the Figures, DU 604 or data component 1742 may receive DL data 904 from CU 606 prior to receiving message 906.

In some examples, at block 1206, the first network entity sends a PDCP status report of the UE to the second network entity. For example, block 1206 may be performed by data component 1742. For instance, referring to the Figures, DU 604 or data component 1742 may transmit PDCP status report 408 to CU 606 in response to receiving PDCP status report 408 from UE 402.

In some examples, in block 1208, the first network entity obtains, from the second network entity, the assistance information indicating an unreceived PDCP SDU at a UE. Block 1208 may correspond to block 1102 of FIG. 11 in connection with downlink scheduling.

In some examples, the assistance information is obtained after the message at block 1202 is obtained. For instance, referring to the Figures, DU 604 or assistance information component 1740 may receive message 906 after message 912. In some examples, the assistance information is received in response to the PDCP status report sent at block 1206. For instance, referring to the Figures, DU 604 or assistance information component 1740 may receive message 906 in response to transmitting PDCP status report 408 to CU 606.

In some examples, the assistance information is a message indicating whether a PDCP PDU including the downlink data is to be sent in a retransmission to the UE. For instance, referring to the Figures, message 906 may indicate to DU 604 whether or not to transmit PDCP PDU 916 including DL data 904 in a retransmission to UE 402. For instance, DU 604 may transmit the PDCP PDU 916 if the DL data 904 is not a duplicate of one or more of unreceived downlink PDCP SDUs 420, or DU 604 may discard the PDCP PDU 916 at block 910 if the DL data 904 is a duplicate of one or more of unreceived downlink PDCP SDUs 420.

In some examples, the assistance information includes at least one of: a UE identifier associated with the UE, a TEID associated with the downlink data, a flow identifier associated with the downlink data, a bearer identifier associated with the downlink data, a PDCP entity identifier associated with the downlink data, a RLC channel identifier associated with the downlink data, a RLC bearer identifier associated with the downlink data, a RLC entity identifier associated with the downlink data, a logical channel identifier associated with the downlink data, a timing for sending the downlink data, or whether a downlink PDCP PDU is to be discarded at the DU. For instance, message 906 may include a UEID associated with UE 402, a TEID associated with DL data 904 or a logical channel or data radio bearer for DL data 904, a flow identifier, bearer identifier, PDCP entity identifier, RLC channel (or bearer or entity) identifier, a logical channel identifier, or a combination of any of the foregoing associated with DL data 904, timing 908 for scheduling DL data 904 at block 914, or whether the DU 604 is to discard the DL data 904 at block 910.

In some examples, in block 1210, the first network entity sends downlink data to the UE based on the assistance information. Block 1210 may correspond to block 1104 of FIG. 11 in connection with downlink scheduling.

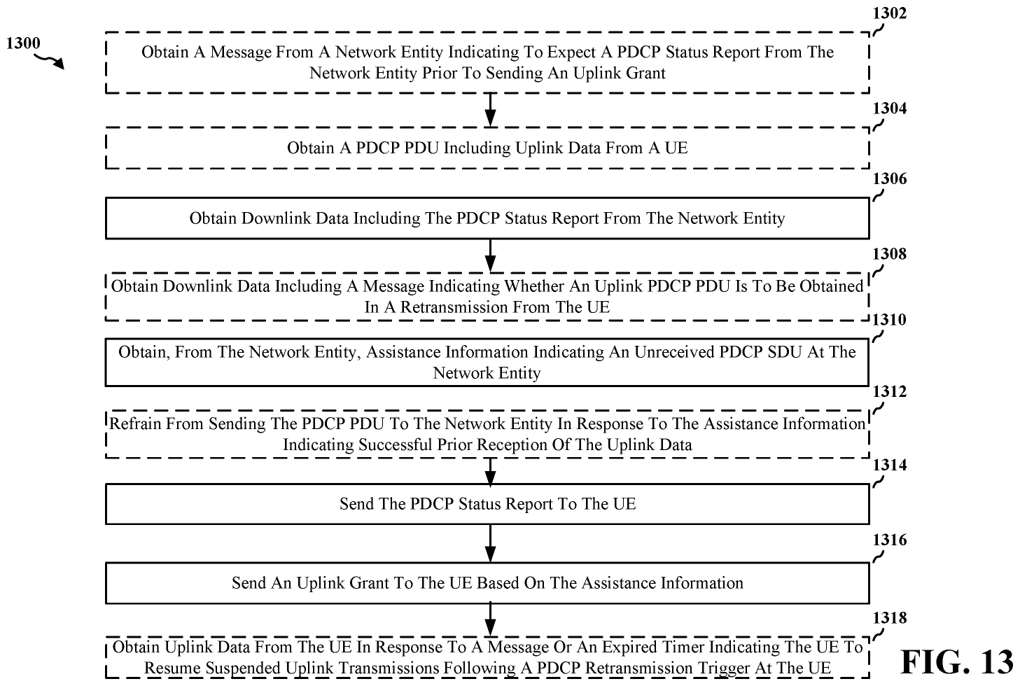

FIG. 13 is a flowchart 1300 of an example method or process for wireless communication performable at a network entity which performs enhanced uplink scheduling based on assistance information related to PDCP status reports. The method may be performed by a first network entity such as a DU, such as DU 185, first wireless device 310 or second wireless device 350, gNB-DU 504, the target DU 604, the apparatus 1702, or its components as described herein. The first network entity may be in communication with a UE, such as UE 104, 402, and with a second network entity such as a CU, such as CU 183, gNB-CU 502, CU 606. In some examples, the DU is in a satellite, the CU is in a ground station, and the DU and CU are part of a NTN. Optional aspects are illustrated in dashed lines.

In some examples, in block 1302, the first network entity obtains a message from the second network entity indicating to expect a PDCP status report from the second network entity prior to sending an uplink grant. For example, block 1302 may be performed by assistance information component 1740. For instance, referring to the Figures, DU 604 or assistance information component 1740 may receive message 1010 from CU 606 indicating to expect PDCP status report 410 or other of assistance information 1002 from CU 606 prior to scheduling uplink grants in block 1012.

In some examples, in block 1304, the first network entity obtains a PDCP PDU including uplink data from the UE prior to obtaining assistance information from the second network entity. For example, block 1304 may be performed by data component 1742. For instance, referring to the Figures, DU 604 or data component 1742 may receive PDCP PDU 1028 including UL data 1030 from UE 402 prior to receiving assistance information 1002 from CU 606.

In some examples, in block 1306, the first network entity obtains downlink data including a PDCP status report from the second network entity. For example, block 1306 may be performed by data component 1742. For instance, referring to the Figures, DU 604 or data component 1742 may receive DL data 1004 including PDCP status report 410 from CU 606.

In some examples, the PDCP status report is obtained after the message in block 1302 is obtained. For instance, referring to the Figures, DU 604 may receive PDCP status report 410 after receiving message 1010 from CU 606.

In some examples, in block 1308, the first network entity obtains downlink data including a message indicating whether an uplink PDCP PDU is to be obtained in a retransmission from the UE. For example, block 1308 may be performed by data component 1742. For instance, referring to the Figures, DU 604 or data component 1742 may receive DL data 1004 including message 1008 indicating whether the DU 604 is to schedule the UE 402 to retransmit UL data 1020 in PDCP PDU 1022 to DU 604 and CU 606. For example, message 1008 may indicate that UL data 1020 in PDCP PDU 1022 is not duplicated in one or more of unreceived PDCP uplink SDUs 422.

In some examples, in block 1310, the first network entity obtains, from the second network entity, the assistance information indicating an unreceived PDCP SDU at the second network entity. Block 1310 may correspond to block 1102 of FIG. 11 in connection with uplink scheduling.

In some examples, the assistance information is a PDCP status report or a message indicating a reception status at the network entity of the PDCP PDU. For instance, referring to the Figures, assistance information 1002 may include PDCP status report 410, or message 1008 indicating whether UL data 1020 in PDCP PDU 1022 has been previously received in one or more of the PDCP uplink SDUs 422. In some examples, the assistance information indicates the PDCP status report is included in the downlink data obtained in block 1306. For instance, referring to the Figures, assistance information 1002 may include message 1006, which indicates that PDCP status report 410 is included in DL data 1004. In some examples, the assistance information indicates the message is included in the downlink data obtained in block 1308, where the message is different than the PDCP status report. For instance, referring to the Figures, assistance information 1002 may include message 1006, which indicates that message 1008 separate from PDCP status report 410 is included in DL data 1004.

In some examples, in block 1312, the first network entity refrains from sending the PDCP PDU including uplink data obtained in block 1304 to the second network entity in response to the assistance information indicating successful prior reception of the uplink data. For example, block 1312 may be performed by data component 1742. For instance, referring to the Figures, DU 604 or data component 1742 may discard at block 1040 the previously received, PDCP PDU 1028 including UL data 1030, rather than transmit this PDCP PDU to CU 606, in response to assistance information 1002 indicating CU 606 previously received uplink data 1030 successfully in a prior transmission (the PDCP PDU 1028 is a duplicate of one or more of previously received PDCP uplink SDUs 422).

In some examples, in block 1314, the first network entity sends the PDCP status report to the UE prior to sending the uplink grant. For example, block 1314 may be performed by data component 1742. For instance, referring to the Figures, DU 604 or data component 1742 may transmit PDCP status report 410 to UE 402 prior to performing uplink scheduling at block 1012 including transmission of uplink grants 1018.

In some examples, in block 1316, the first network entity sends the uplink grant to the UE based on the assistance information. Block 1316 may correspond to block 1104 of FIG. 11 in connection with uplink scheduling.

In some examples, the uplink grant is sent in response to sending of the PDCP status report in block 1314, in response to an acknowledgement from the UE of the PDCP status report, or in response to an elapsed period of time following the sending of the PDCP status report. For instance, referring to the Figures, DU 604 may begin performing uplink scheduling at block 1012 including transmission of uplink grants 1018 in response to transmission of PDCP status report 410 to UE 402, in response to receiving ACK 1014 from UE 402 of the PDCP status report 410, or in response to elapsed time period 1016 following transmission of PDCP status report 410.

In some examples, in block 1318, the first network entity obtains uplink data from the UE in response to a message or an expired timer indicating the UE to resume suspended uplink transmissions following a PDCP retransmission trigger at the UE. For example, block 1318 may be performed by data component 1742. For instance, referring to the Figures, DU 604 or data component 1742 may receive uplink data 1020 from UE 402 in response to transmission of message 1034 or expiration of UE timer 1036, either of which indicates UE 402 to resume transmissions of PDCP data PDUs at block 1038 following UE suspension of such transmissions at block 1032 in response to HO command 416 or other PDCP retransmission trigger.

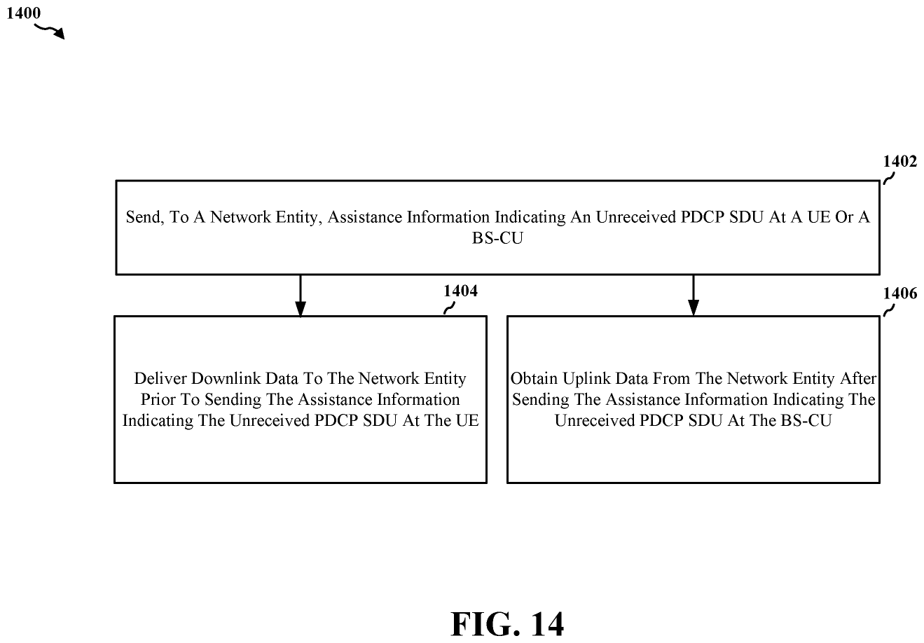

FIG. 14 is a flowchart 1400 of an example method or process for wireless communication performable at a network entity which provides assistance information related to PDCP status reports for enhanced downlink and uplink scheduling. The method may be performed by a first network entity such as a CU, such as CU 183, first wireless device 310, gNB-CU 502, CU 606, the apparatus 1802, or its components as described herein. The first network entity may be in communication with a second network entity such as a DU, such as DU 185, gNB-DU 504, the target DU 604. In some examples, the DU is in a satellite, the CU is in a ground station, and the DU and CU are part of a NTN.

In some examples, in block 1402, the first network entity sends, to a second network entity, assistance information indicating an unreceived PDCP SDU at a UE or the first network entity. For example, block 1402 may be performed by assistance information component 1840. For instance, referring to the Figures, CU 606 or assistance information component 1840 may transmit to DU 604 assistance information 902, 1002 indicating unreceived PDCP SDUs 420, 422 at UE 402 or CU 606 respectively.

In some examples, the first network entity may perform one or more of the operations in block 1404 for downlink scheduling or block 1406 for uplink scheduling. In some examples related to downlink scheduling, in block 1404, the first network entity delivers downlink data to the second network entity prior to sending the assistance information indicating the unreceived PDCP SDU at the UE. For example, block 1404 may be performed by data component 1842. For instance, referring to the Figures, CU 606 or data component 1842 may transmit DL data 904 to DU 604 prior to transmitting to DU 604 assistance information 902 indicating unreceived PDCP SDUs 420 at UE 402. In some examples related to uplink scheduling, in block 1406, the first network entity obtains uplink data from the second network entity after sending the assistance information indicating the unreceived PDCP SDU at the first network entity. For example, block 1406 may be performed by data component 1842. For instance, referring to the Figures, CU 606 or data component 1842 may receive UL data 1020 from DU 604 after transmitting to DU 604 assistance information 1002 indicating unreceived PDCP SDUs 422 at CU 606.

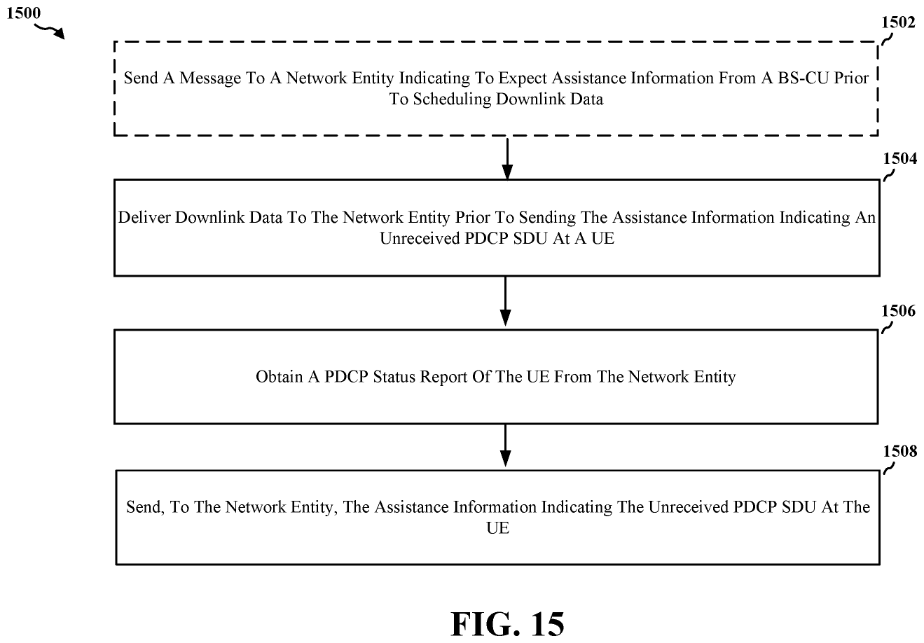

FIG. 15 is a flowchart 1500 of an example method or process for wireless communication performable at a network entity which provides assistance information related to PDCP status reports for enhanced downlink scheduling. The method may be performed by a first network entity such as a CU, such as CU 183, first wireless device 310, gNB-CU 502, CU 606, the apparatus 1802, or its components as described herein. The first network entity may be in communication with a second network entity such as a DU, such as DU 185, gNB-DU 504, the target DU 604. In some examples, the DU is in a satellite, the CU is in a ground station, and the DU and CU are part of a NTN. Optional aspects are illustrated in dashed lines.

In some examples, in block 1502, the first network entity sends a message to the second network entity indicating to expect assistance information from the first network entity prior to scheduling downlink data. For example, block 1502 may be performed by assistance information component 1840. For instance, referring to the Figures, CU 606 or assistance information component 1840 may transmit message 912 to DU 604 indicating to DU 604 to expect message 906 from CU 606 before DU 604 begins scheduling downlink data 904 to UE 402 at block 914.

In some examples, in block 1504, the first network entity delivers downlink data to the second network entity. Block 1504 may correspond to block 1404 of FIG. 14 in connection with downlink scheduling.

In some examples, in block 1506, the first network entity obtains a PDCP status report of the UE from the second network entity. For example, block 1502 may be performed by data component 1842. For instance, referring to the Figures, CU 606 or data component 1842 may receive PDCP status report 408 of UE 402 from DU 604.

In some examples, in block 1508, the first network entity sends, to the second network entity, the assistance information indicating an unreceived PDCP SDU at the UE. Block 1508 may correspond to block 1402 of FIG. 14 in connection with downlink scheduling.

In some examples, the downlink data in block 1504 is delivered prior to sending the assistance information indicating the unreceived PDCP SDU at the UE. For instance, referring to the Figures, CU 606 may transmit DL data 904 to DU 604 prior to transmitting message 906 indicating unreceived PDCP SDUs 420 at UE 402.

In some examples, the assistance information in block 1508 is sent after the message in block 1502 is sent. For instance, referring to the Figures, CU 606 may transmit message 906 to DU 604 after transmitting message 912 to DU 604.

In some examples, the assistance information in block 1508 is sent in response to the PDCP status report obtained in block 1506. For instance, referring to the Figures, CU 606 may transmit message 906 to DU 604 in response to receiving PDCP status report 408 of UE 402 from DU 604.

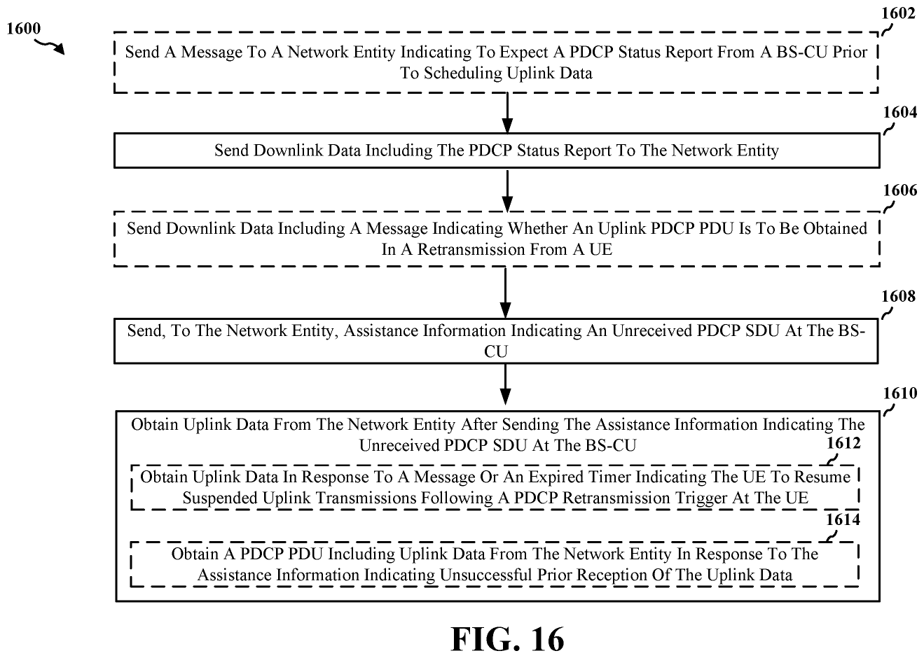

FIG. 16 is a flowchart 1600 of an example method or process for wireless communication performable at a network entity which provides assistance information related to PDCP status reports for enhanced uplink scheduling. The method may be performed by a first network entity such as a CU, such as CU 183, first wireless device 310, gNB-CU 502, CU 606, the apparatus 1802, or its components as described herein. The first network entity may be in communication with a second network entity such as a DU, such as DU 185, gNB-DU 504, the target DU 604. In some examples, the DU is in a satellite, the CU is in a ground station, and the DU and CU are part of a NTN. Optional aspects are illustrated in dashed lines.

In some examples, in block 1602, the first network entity sends a message to the second network entity indicating to expect a PDCP status report from the first network entity prior to scheduling uplink data. For example, block 1602 may be performed by assistance information component 1840. For instance, referring to the Figures, CU 606 or assistance information component 1840 may transmit message 1010 to DU 604 indicating to DU 604 to expect PDCP status report 410 or other assistance information from CU 606 prior to scheduling transmissions of uplink data 1020 at block 1012.

In some examples, in block 1604, the first network entity sends downlink data including a PDCP status report to the second network entity. For example, block 1604 may be performed by data component 1842. For instance, referring to the Figures, CU 606 or data component 1842 may transmit DL data 1004 including PDCP status report 410 to DU 604.

In some examples, the PDCP status report in block 1604 is sent after the message in block 1602 is sent. For instance, referring to the Figures, CU 606 may transmit PDCP status report 410 in DL data 1004 to DU 604 after transmitting message 1010 to DU 604.

In some examples, in block 1606, the first network entity sends downlink data including a message indicating whether an uplink PDCP PDU is to be obtained in a retransmission from the UE. For example, block 1606 may be performed by data component 1842. For instance, referring to the Figures, CU 606 or data component 1842 may transmit DL data 1004 including message 1008 indicating whether DU 604 is to schedule UE 402 is to retransmit uplink data 1020 in PDCP PDU 1022. For example, message 1008 may indicate to DU 604 whether uplink data 1020 in PDCP PDU 1022 is not a duplicate of one or more previously received uplink SDUs from UE 402.

In some examples, in block 1608, the first network entity sends, to the second network entity, assistance information indicating an unreceived PDCP SDU at the first network entity. Block 1608 may correspond to block 1402 of FIG. 14 in connection with uplink scheduling.

In some examples, the assistance information indicates the PDCP status report is included in the downlink data sent in block 1604. For instance, referring to the Figures, CU 606 may transmit message 1006 to DU 604 indicating PDCP status report 410 is included in DL data 1004.

In some examples, the assistance information indicates the message in block 1606 is included in the downlink data sent in block 1606, where the message is different than a PDCP status report. For instance, referring to the Figures, CU 606 may transmit message 1006 to DU 604 indicating message 1008 is included in DL data 1004.

In some examples, in block 1610, the first network entity obtains uplink data from the second network entity after sending the assistance information indicating the unreceived PDCP SDU at the first network entity. Block 1610 may correspond to block 1406 of FIG. 14 in connection with uplink scheduling.

In some examples, in block 1612, the first network entity obtains the uplink data in block 1610 in response to a message or an expired timer indicating the UE to resume suspended uplink transmissions following a PDCP retransmission trigger at the UE. For example, block 1612 may be performed by data component 1842. For instance, referring to the Figures, CU 606 or data component 1842 may receive UL data 1020 in response to message 1034 or expiration of UE timer 1036 indicating UE 402 to resume PDCP PDU transmissions at block 1038 following suspension of such transmissions at block 1032 in response to HO command 416 or other PDCP retransmission trigger at UE 402.

In some examples, in block 1614, the first network entity obtains a PDCP PDU including the uplink data from the second network entity in block 1610 in response to the assistance information indicating unsuccessful prior reception of the uplink data, where the assistance information in block 1608 is sent following a transmission of the uplink data from the UE to the second network entity. For example, block 1614 may be performed by data component 1842. For instance, referring to the Figures, CU 606 or data component 1842 may receive PDCP PDU 1028 including UL data 1030 from DU 604 in response to message 1006 indicating the UL data 1030 is in one or more unreceived PDCP uplink SDUs 422 or that the PDCP PDU 1028 is not a duplicate of a previously received uplink transmission from UE 402, and thus in response to the DU 604 not discarding UL data 1030 at block 1040. CU 606 may transmit message 1006 after UE 402 transmits UL data 1030 in PDCP PDU 1028 to DU 604.

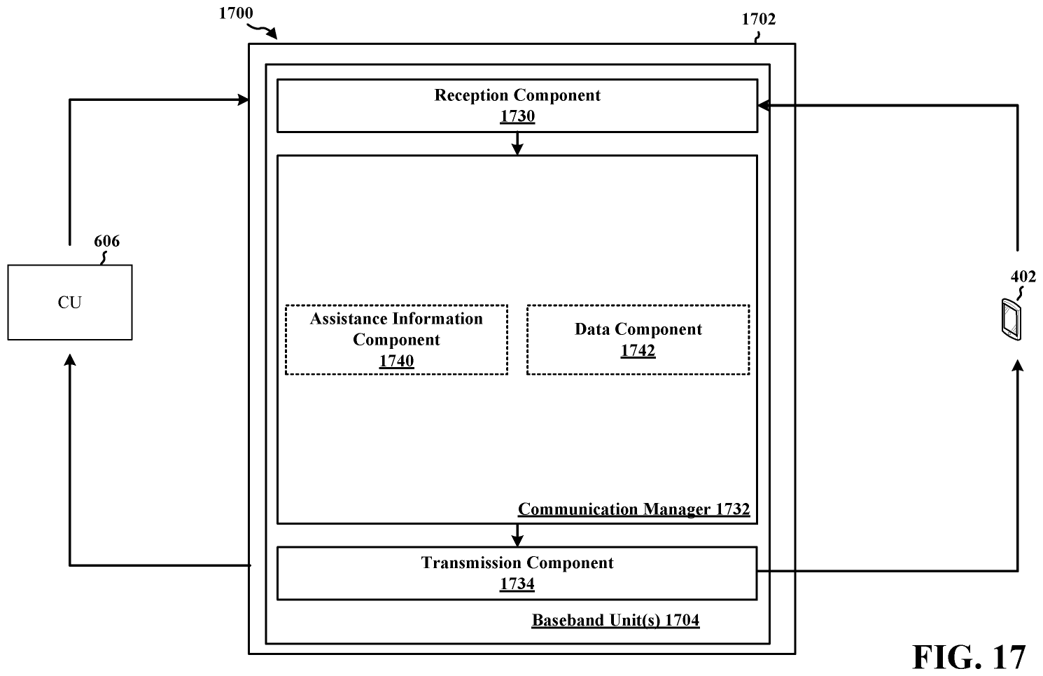

FIG. 17 is a diagram 1700 illustrating an example of a hardware implementation for an apparatus 1702 that performs enhanced downlink and uplink scheduling based on assistance information related to PDCP status reports according to some aspects of the present disclosure. The apparatus 1702 is a DU such as DU 604 and includes one or more baseband units 1704. The one or more baseband units 1704 may communicate through a cellular RF transceiver with the UE 402 and CU 606. The one or more baseband units 1704 may each include a computer-readable medium/one or more memories. The computer-readable medium/one or more memories may be non-transitory. The one or more baseband units 1704 are responsible for general processing, including the execution of software stored on the computer-readable medium/one or more memories individually or in combination. The software, when executed by the one or more baseband units 1704, causes the one or more baseband units 1704 to, individually or in combination, perform the various functions described supra. The computer-readable medium/one or more memories may also be used individually or in combination for storing data that is manipulated by the one or more baseband units 1704 when executing software. The one or more baseband units 1704 individually or in combination further include a reception component 1730, a communication manager 1732, and a transmission component 1734. The communication manager 1732 includes the one or more illustrated components. The components within the communication manager 1732 may be stored in the computer-readable medium/one or more memories and/or configured as hardware within the one or more baseband units 1704. The one or more baseband units 1704 may be components of the DU 185, wireless device 310 or 350, gNB-DU 504, or DU 604. In one example, the one or more baseband units 1704 may individually or in combination include the one or more memories 360 and/or at least one of the one or more TX processors 368, at least one of the one or more RX processors 356, and at least one of the one or more controllers/processors 359. In another example, the one or more baseband units 1704 may individually or in combination include the one or more memories 376 and/or at least one of the one or more TX processors 316, at least one of the one or more RX processors 370, and at least one of the one or more controllers/processors 375.

The communication manager 1732 includes an assistance information component 1740 that is configured to obtain via reception component 1730, from a network entity such as CU 606, assistance information indicating an unreceived PDCP SDU at a UE or the network entity, such as described in connection with blocks 1102, 1208, and 1310 of FIGS. 11-13. The reception component 1730 may be configured to receive, demodulate and decode the assistance information from the network entity and provide the demodulated and decoded assistance information to the assistance information component 1740, where the reception, demodulation and decoding may be performed such as described in connection with FIG. 3. The communication manager 1732 further includes a data component 1742 that is configured to obtain the assistance information from assistance information component 1740 and send, via transmission component 1734, downlink data or an uplink grant to the UE based on the assistance information, such as described in connection with blocks 1104, 1210, and 1316 of FIGS. 11-13. The transmission component 1734 may be configured to obtain the downlink data or uplink grant from the data component 1742 and encode, modulate, and transmit the downlink data or uplink grant to the UE, where the coding, modulation, and transmission may be performed such as described in connection with FIG. 3.

The assistance information component 1740 may also be configured to obtain via reception component 1730 a message from the network entity indicating to expect assistance information, such as a message or a PDCP status report, from the network entity prior to sending downlink data or the uplink grant, such as described in connection with blocks 1202 and 1302 of FIGS. 12 and 13. The data component 1742 may also be configured to obtain via reception component 1730 downlink data from the network entity, to send via transmission component 1734 a PDCP status report of a UE to the network entity, to obtain via reception component 1730 a PDCP PDU including uplink data from a UE, to obtain via reception component 1730 downlink data including the PDCP status report from the network entity, to obtain via reception component 1730 downlink data including a message indicating whether an uplink PDCP PDU is to be obtained in a retransmission from the UE, to refrain from sending via transmission component 1734 the PDCP PDU to the network entity in response to the assistance information indicating successful prior reception of the uplink data, to send via transmission component 1734 the PDCP status report to the UE, and/or to obtain via reception component 1730 uplink data from the UE in response to a message or an expired timer indicating the UE to resume suspended uplink transmissions following a PDCP retransmission trigger at the UE, such as described in connection with blocks 1204, 1206, 1304, 1306, 1308, 1312, 1314, and 1318 respectively of FIGS. 12 and 13.

The apparatus 1702 may include additional components that perform each of the blocks of the algorithm in the aforementioned flowcharts of FIGS. 11-13. As such, each block in the aforementioned flowcharts of FIGS. 11-13 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1702, and in particular the one or more baseband units 1704, includes means for obtaining, from a network entity, assistance information indicating an unreceived PDCP SDU at a UE or the network entity; and means for sending downlink data or an uplink grant to the UE based on the assistance information.

In one configuration, the means for obtaining is further configured to obtain the downlink data from the network entity prior to obtaining the assistance information.

In one configuration, the means for obtaining is further configured to obtain a message from the network entity indicating to expect the assistance information from the network entity prior to sending the downlink data, the assistance information being obtained after the message is obtained.

In one configuration, the means for sending is further configured to send a PDCP status report of the UE to the network entity, wherein the assistance information is received in response to the PDCP status report.

In one configuration, the means for obtaining is further configured to obtain downlink data including a PDCP status report from the network entity, wherein the assistance information indicates the PDCP status report is included in the downlink data.

In one configuration, the means for obtaining is further configured to obtain a message from the network entity indicating to expect the PDCP status report from the network entity prior to sending the uplink grant, the PDCP status report being obtained after the message is obtained.

In one configuration, the means for sending is further configured to send the PDCP status report to the UE prior to sending the uplink grant.

In one configuration, the means for obtaining is further configured to obtain downlink data including a message indicating whether an uplink PDCP PDU is to be obtained in a retransmission from the UE, the assistance information indicating the message is included in the downlink data, the message being different than a PDCP status report.

In one configuration, the means for obtaining is further configured to obtain uplink data from the UE in response to a message or an expired timer indicating the UE to resume suspended uplink transmissions following a PDCP retransmission trigger at the UE.

In one configuration, the means for obtaining is further configured to obtain a PDCP PDU including uplink data from the UE prior to obtaining the assistance information from the network entity; and the means for sending is further configured to refrain from sending the PDCP PDU to the network entity in response to the assistance information indicating successful prior reception of the uplink data.

The aforementioned means may be one or more of the aforementioned components of the apparatus 1702 configured to perform the functions recited by the aforementioned means. As described supra, in one example, the apparatus 1702 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means. In another example, the apparatus 1702 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

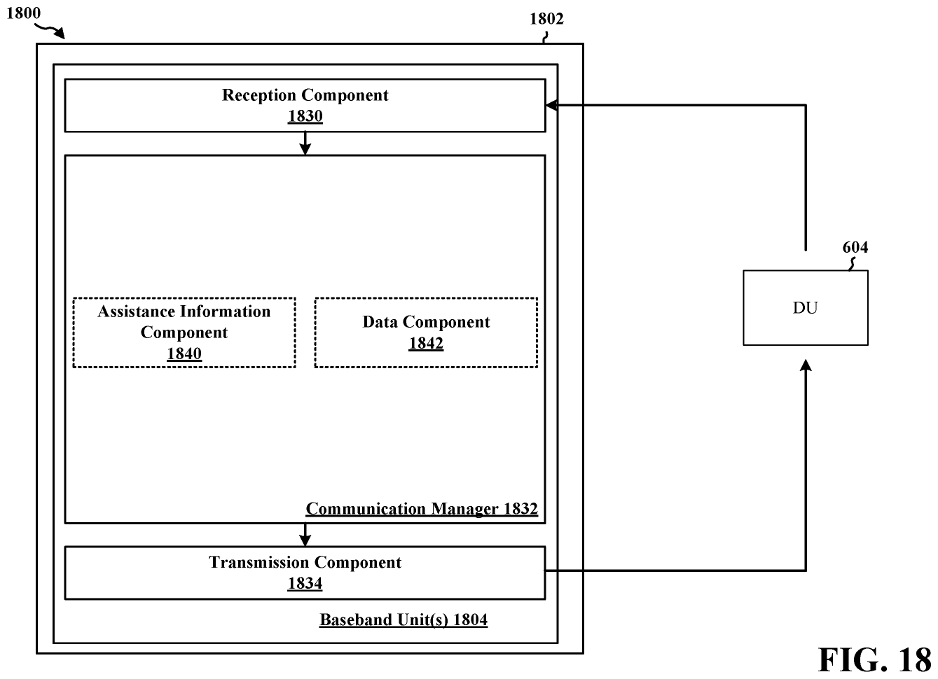

FIG. 18 is a diagram 1800 illustrating an example of a hardware implementation for an apparatus 1802 that provides assistance information related to PDCP status reports for enhanced downlink and uplink scheduling according to some aspects of the present disclosure. The apparatus 1802 is a CU such as CU 606 and includes one or more baseband units 1804. The one or more baseband units 1804 may communicate through a cellular RF transceiver with DU 604. The one or more baseband units 1804 may each include a computer-readable medium/one or more memories. The computer-readable medium/one or more memories may be non-transitory. The one or more baseband units 1804 are responsible for general processing, including the execution of software stored on the computer-readable medium/one or more memories individually or in combination. The software, when executed by the one or more baseband units 1804, causes the one or more baseband units 1804 to, individually or in combination, perform the various functions described supra. The computer-readable medium/one or more memories may also be used individually or in combination for storing data that is manipulated by the one or more baseband units 1804 when executing software. The one or more baseband units 1804 individually or in combination further include a reception component 1830, a communication manager 1832, and a transmission component 1834. The communication manager 1832 includes the one or more illustrated components. The components within the communication manager 1832 may be stored in the computer-readable medium/one or more memories and/or configured as hardware within the one or more baseband units 1804. The one or more baseband units 1804 may be components of the CU 183, wireless device 310, gNB-CU 502, or CU 606 and may individually or in combination include the one or more memories 376 and/or at least one of the one or more TX processors 316, at least one of the one or more RX processors 370, and at least one of the one or more controllers/processors 375.

The communication manager 1832 includes an assistance information component 1840 that is configured to send via transmission component 1834, to a network entity such as DU 604, assistance information indicating an unreceived PDCP SDU at a UE or the apparatus 1802, such as described in connection with blocks 1402, 1508, 1608 of FIGS. 14-16. The communication manager 1832 further includes a data component 1842 that is configured to obtain the assistance information from assistance information component 1840, and at least one of: deliver downlink data via transmission component 1834 to the network entity prior to sending the assistance information indicating the unreceived PDCP SDU at the UE, such as described in connection with blocks 1404 and 1504 of FIGS. 14 and 15, or obtain uplink data via reception component 1830 from the network entity after sending the assistance information indicating the unreceived PDCP SDU at the apparatus 1802, such as described in connection with blocks 1406 and 1610 of FIGS. 14 and 16. The transmission component 1834 may be configured to obtain at least one of the assistance information from the assistance information component 1840 or the downlink data from the data component 1842, and encode, modulate, and transmit the assistance information or the downlink data to the network entity, where the coding, modulation, and transmission may be performed such as described in connection with FIG. 3. The reception component 1830 may be configured to receive, demodulate and decode the uplink data from the network entity and provide the demodulated and decoded uplink data to the data component 1842, where the reception, demodulation and decoding may be performed such as described in connection with FIG. 3.

The assistance information component 1840 may also be configured to send via transmission component 1834 a message to the network entity indicating to expect assistance information from the apparatus 1802 prior to scheduling downlink data, and/or to send via transmission component 1834 a message to the network entity indicating to expect a PDCP status report from the apparatus 1802 prior to scheduling uplink data, such as described in connection with block 1502 and 1602 of FIGS. 15 and 16.

The data component 1842 may also be configured to obtain via reception component 1830 a PDCP status report of the UE from the network entity, to send via transmission component 1834 downlink data including the PDCP status report to the network entity, to send via transmission component 1834 downlink data including a message indicating whether an uplink PDCP PDU is to be obtained in a retransmission from the UE, to obtain via reception component 1830 uplink data in response to a message or an expired timer indicating the UE to resume suspended uplink transmissions following a PDCP retransmission trigger at the UE, and/or to obtain via reception component 1830 a PDCP PDU including the uplink data from the network entity in response to the assistance information indicating unsuccessful prior reception of the uplink data, such as described in connection with blocks 1506, 1604, 1606, 1608, 1612, and 1614 of FIGS. 15 and 16.

The apparatus 1802 may include additional components that perform each of the blocks of the algorithm in the aforementioned flowcharts of FIGS. 14-16. As such, each block in the aforementioned flowcharts of FIGS. 14-16 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1802, and in particular the one or more baseband units 1804, includes means for sending, to a network entity, assistance information indicating an unreceived PDCP SDU at a UE or the apparatus; and one of: means for delivering downlink data to the network entity prior to sending the assistance information indicating the unreceived PDCP SDU at the UE; or means for obtaining uplink data from the network entity after sending the assistance information indicating the unreceived PDCP SDU at the apparatus.

In one configuration, the means for sending is further configured to send a message to the network entity indicating to expect the assistance information from the apparatus prior to scheduling the downlink data, the assistance information being sent after the message is sent.

In one configuration, the means for obtaining is further configured to obtain a PDCP status report of the UE from the network entity, the assistance information being sent in response to the PDCP status report.

In one configuration, the means for sending is further configured to send downlink data including a PDCP status report to the network entity, wherein the assistance information indicates the PDCP status report is included in the downlink data.

In one configuration, the means for sending is further configured to send a message to the network entity indicating to expect a PDCP status report from the apparatus prior to scheduling uplink data, the PDCP status report being sent after the message is sent.

In one configuration, the means for sending is further configured to send downlink data including a message indicating whether an uplink PDCP PDU is to be obtained in a retransmission from the UE, the assistance information indicating the message is included in the downlink data, and the message being different than a PDCP status report.

In one configuration, the means for obtaining is further configured to obtain uplink data in response to a message or an expired timer indicating the UE to resume suspended uplink transmissions following a PDCP retransmission trigger at the UE.

In one configuration, the means for obtaining is further configured to obtain a PDCP PDU including uplink data from the network entity in response to the assistance information indicating unsuccessful prior reception of the uplink data, wherein the assistance information is sent following a transmission of the uplink data from the UE to the network entity.

The aforementioned means may be one or more of the aforementioned components of the apparatus 1802 configured to perform the functions recited by the aforementioned means. As described supra, the apparatus 1802 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain, from a network entity, assistance information indicating an unreceived PDCP SDU at a UE or the network entity; and send downlink data or an uplink grant to the UE based on the assistance information.

Clause 2. The apparatus of clause 1, wherein the assistance information indicates the unreceived PDCP SDU at the UE, and the downlink data is sent based on the assistance information.

Clause 3. The apparatus of clause 2, wherein the one or more processors, individually or in combination, are further operable to cause the apparatus to: obtain the downlink data from the network entity prior to obtaining the assistance information.

Clause 4. The apparatus of clause 2 or clause 3, wherein the one or more processors, individually or in combination, are further operable to cause the apparatus to: obtain a message from the network entity indicating to expect the assistance information from the network entity prior to sending the downlink data, the assistance information being obtained after the message is obtained.

Clause 5. The apparatus of clause 4, wherein the message includes at least one of: a UE identifier associated with the UE, a TEID associated with the downlink data, a flow identifier associated with the downlink data, a bearer identifier associated with the downlink data, a PDCP entity identifier associated with the downlink data, a RLC channel identifier associated with the downlink data, a RLC bearer identifier associated with the downlink data, a RLC entity identifier associated with the downlink data, or a logical channel identifier associated with the downlink data.

Clause 6. The apparatus of any of clauses 2 to 5, wherein the one or more processors, individually or in combination, are further operable to cause the apparatus to: send a PDCP status report of the UE to the network entity, wherein the assistance information is received in response to the PDCP status report.

Clause 7. The apparatus of any of clauses 2 to 6, wherein the assistance information is a message indicating whether a PDCP PDU including the downlink data is to be sent in a retransmission to the UE.

Clause 8. The apparatus of clause 7, wherein the assistance information includes at least one of: a UE identifier associated with the UE, a TEID associated with the downlink data, a flow identifier associated with the downlink data, a bearer identifier associated with the downlink data, a PDCP entity identifier associated with the downlink data, a RLC channel identifier associated with the downlink data, a RLC bearer identifier associated with the downlink data, a RLC entity identifier associated with the downlink data, a logical channel identifier associated with the downlink data, a timing for sending the downlink data, or whether a downlink PDCP PDU is to be discarded at the apparatus.

Clause 9. The apparatus of clause 1, wherein the assistance information indicates the unreceived PDCP SDU at the network entity, and the uplink grant is sent based on the assistance information.

Clause 10. The apparatus of clause 9, wherein the one or more processors, individually or in combination, are further operable to cause the apparatus to: obtain downlink data including a PDCP status report from the network entity, wherein the assistance information indicates the PDCP status report is included in the downlink data.

Clause 11. The apparatus of clause 10, wherein the one or more processors, individually or in combination, are further operable to cause the apparatus to: obtain a message from the network entity indicating to expect the PDCP status report from the network entity prior to sending the uplink grant, the PDCP status report being obtained after the message is obtained.

Clause 12. The apparatus of clause 10 or clause 11, wherein the one or more processors, individually or in combination, are further operable to cause the apparatus to: send the PDCP status report to the UE prior to sending the uplink grant.

Clause 13. The apparatus of any of clauses 10 to 12, wherein the uplink grant is sent in response to sending of the PDCP status report, in response to an acknowledgement from the UE of the PDCP status report, or in response to an elapsed period of time following the sending of the PDCP status report.

Clause 14. The apparatus of any of clauses 9 to 13, wherein the one or more processors, individually or in combination, are further operable to cause the apparatus to: obtain downlink data including a message indicating whether an uplink PDCP PDU is to be obtained in a retransmission from the UE, the assistance information indicating the message is included in the downlink data, the message being different than a PDCP status report.

Clause 15. The apparatus of any of clauses 9 to 14, wherein the one or more processors, individually or in combination, are further operable to cause the apparatus to: obtain uplink data from the UE in response to a message or an expired timer indicating the UE to resume suspended uplink transmissions following a PDCP retransmission trigger at the UE.

Clause 16. The apparatus of any of clauses 9 to 15, wherein the one or more processors, individually or in combination, are further operable to cause the apparatus to: obtain a PDCP PDU including uplink data from the UE prior to obtaining the assistance information from the network entity; and refrain from sending the PDCP PDU to the network entity in response to the assistance information indicating successful prior reception of the uplink data.

Clause 17. The apparatus of clause 16, wherein the assistance information is a PDCP status report or a message indicating a reception status at the network entity of the PDCP PDU.

Clause 18. The apparatus of any of clauses 1 to 17, wherein the apparatus is a DU, and the network entity is a CU.

Clause 19. The apparatus of clause 18, wherein the apparatus is in a satellite, the network entity is in a ground station, and the apparatus and the network entity are part of a NTN.

Clause 20. The apparatus of ay of clauses 1 to 19, wherein the downlink data or the uplink grant is for at least one logical channel of a plurality of logical channels configured for the UE.

Clause 21. An apparatus for wireless communication, comprising: one or more memories; and one or more processors each communicatively coupled with at least one of the one or more memories, the one or more processors, individually or in any combination, operable to cause the apparatus to: send, to a network entity, assistance information indicating an unreceived PDCP SDU at a UE or the apparatus; and one of: deliver downlink data to the network entity prior to sending the assistance information indicating the unreceived PDCP SDU at the UE; or obtain uplink data from the network entity after sending the assistance information indicating the unreceived PDCP SDU at the apparatus.

Clause 22. The apparatus of clause 21, wherein the one or more processors, individually or in combination, are further operable to cause the apparatus to: send a message to the network entity indicating to expect the assistance information from the apparatus prior to scheduling the downlink data, the assistance information being sent after the message is sent.

Clause 23. The apparatus of clause 21 or 22, wherein the one or more processors, individually or in combination, are further operable to cause the apparatus to: obtain a PDCP status report of the UE from the network entity, the assistance information being sent in response to the PDCP status report.

Clause 24. The apparatus of clause 21, wherein the one or more processors, individually or in combination, are further operable to cause the apparatus to: send downlink data including a PDCP status report to the network entity, wherein the assistance information indicates the PDCP status report is included in the downlink data.

Clause 25. The apparatus of clause 21 or 24, wherein the one or more processors, individually or in combination, are further operable to cause the apparatus to: send a message to the network entity indicating to expect a PDCP status report from the apparatus prior to scheduling uplink data, the PDCP status report being sent after the message is sent.

Clause 26. The apparatus of clauses 21, 24, or 25, wherein the one or more processors, individually or in combination, are further operable to cause the apparatus to: send downlink data including a message indicating whether an uplink PDCP PDU is to be obtained in a retransmission from the UE, the assistance information indicating the message is included in the downlink data, and the message being different than a PDCP status report.

Clause 27. The apparatus of clause 21 or any of clauses 24 to 26, wherein the one or more processors, individually or in combination, are further operable to cause the apparatus to: obtain uplink data in response to a message or an expired timer indicating the UE to resume suspended uplink transmissions following a PDCP retransmission trigger at the UE.

Clause 28. The apparatus of clause 21 or any of clauses 24 to 27, wherein the one or more processors, individually or in combination, are further operable to cause the apparatus to: obtain a PDCP PDU including uplink data from the network entity in response to the assistance information indicating unsuccessful prior reception of the uplink data, wherein the assistance information is sent following a transmission of the uplink data from the UE to the network entity.

Clause 29. A method for wireless communication performable at a first network entity, comprising: obtaining, from a second network entity, assistance information indicating an unreceived PDCP SDU at a UE or the second network entity; and sending downlink data or an uplink grant to the UE based on the assistance information.

Clause 30. A method for wireless communication performable at a first network entity, comprising: sending, to a second network entity, assistance information indicating an unreceived PDCP SDU at a UE or the first network entity; and one of: delivering downlink data to the second network entity prior to sending the assistance information indicating the unreceived PDCP SDU at the UE; or obtaining uplink data from the second network entity after sending the assistance information indicating the unreceived PDCP SDU at the first network entity.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain, from a network entity, assistance information indicating an unreceived Packet Data Convergence Protocol (PDCP) service data unit (SDU) at a user equipment (UE) or the network entity; and
send downlink data or an uplink grant to the UE based on the assistance information.

2. The apparatus of claim 1, wherein the assistance information indicates the unreceived PDCP SDU at the UE, and the downlink data is sent based on the assistance information.

3. The apparatus of claim 2, wherein the one or more processors, individually or in combination, are further operable to cause the apparatus to:
obtain the downlink data from the network entity prior to obtaining the assistance information.

4. The apparatus of claim 2, wherein the one or more processors, individually or in combination, are further operable to cause the apparatus to:
obtain a message from the network entity indicating to expect the assistance information from the network entity prior to sending the downlink data, the assistance information being obtained after the message is obtained.

5. The apparatus of claim 4, wherein the message includes at least one of: a UE identifier associated with the UE, a tunnel endpoint identifier (TEID) associated with the downlink data, a flow identifier associated with the downlink data, a bearer identifier associated with the downlink data, a PDCP entity identifier associated with the downlink data, a radio link control (RLC) channel identifier associated with the downlink data, a RLC bearer identifier associated with the downlink data, a RLC entity identifier associated with the downlink data, or a logical channel identifier associated with the downlink data.

6. The apparatus of claim 2, wherein the one or more processors, individually or in combination, are further operable to cause the apparatus to:
send a PDCP status report of the UE to the network entity, wherein the assistance information is received in response to the PDCP status report.

7. The apparatus of claim 2, wherein the assistance information is a message indicating whether a PDCP protocol data unit (PDU) including the downlink data is to be sent in a retransmission to the UE.

8. The apparatus of claim 7, wherein the assistance information includes at least one of: a UE identifier associated with the UE, a tunnel endpoint identifier (TEID) associated with the downlink data, a flow identifier associated with the downlink data, a bearer identifier associated with the downlink data, a PDCP entity identifier associated with the downlink data, a radio link control (RLC) channel identifier associated with the downlink data, a RLC bearer identifier associated with the downlink data, a RLC entity identifier associated with the downlink data, or a logical channel identifier associated with the downlink data, a timing for sending the downlink data, or whether a downlink PDCP protocol data unit (PDU) is to be discarded at the apparatus.

9. The apparatus of claim 1, wherein the assistance information indicates the unreceived PDCP SDU at the network entity, and the uplink grant is sent based on the assistance information.

10. The apparatus of claim 9, wherein the one or more processors, individually or in combination, are further operable to cause the apparatus to:
obtain downlink data including a PDCP status report from the network entity, wherein the assistance information indicates the PDCP status report is included in the downlink data.

11. The apparatus of claim 10, wherein the one or more processors, individually or in combination, are further operable to cause the apparatus to:
obtain a message from the network entity indicating to expect the PDCP status report from the network entity prior to sending the uplink grant, the PDCP status report being obtained after the message is obtained.

12. The apparatus of claim 10, wherein the one or more processors, individually or in combination, are further operable to cause the apparatus to:
send the PDCP status report to the UE prior to sending the uplink grant.

13. The apparatus of claim 10, wherein the uplink grant is sent in response to sending of the PDCP status report, in response to an acknowledgement from the UE of the PDCP status report, or in response to an elapsed period of time following the sending of the PDCP status report.

14. The apparatus of claim 9, wherein the one or more processors, individually or in combination, are further operable to cause the apparatus to:
obtain downlink data including a message indicating whether an uplink PDCP protocol data unit (PDU) is to be obtained in a retransmission from the UE, the assistance information indicating the message is included in the downlink data, the message being different than a PDCP status report.

15. The apparatus of claim 9, wherein the one or more processors, individually or in combination, are further operable to cause the apparatus to:
obtain uplink data from the UE in response to a message or an expired timer indicating the UE to resume suspended uplink transmissions following a PDCP retransmission trigger at the UE.

16. The apparatus of claim 9, wherein the one or more processors, individually or in combination, are further operable to cause the apparatus to:
obtain a PDCP protocol data unit (PDU) including uplink data from the UE prior to obtaining the assistance information from the network entity; and
refrain from sending the PDCP PDU to the network entity in response to the assistance information indicating successful prior reception of the uplink data.

17. The apparatus of claim 16, wherein the assistance information is a PDCP status report or a message indicating a reception status at the network entity of the PDCP PDU.

18. The apparatus of claim 1, wherein the apparatus is a distributed unit (DU), and the network entity is a central unit (CU).

19. The apparatus of claim 18, wherein the apparatus is in a satellite, the network entity is in a ground station, and the apparatus and the network entity are part of a non-terrestrial network (NTN).

20. The apparatus of claim 1, wherein the downlink data or the uplink grant is for at least one logical channel of a plurality of logical channels configured for the UE.

21. An apparatus for wireless communication, comprising:
one or more memories; and
one or more processors each communicatively coupled with at least one of the one or more memories, the one or more processors, individually or in any combination, operable to cause the apparatus to:
send, to a network entity, assistance information indicating an unreceived Packet Data Convergence Protocol (PDCP) service data unit (SDU) at a user equipment (UE) or the apparatus; and
one of:
deliver downlink data to the network entity prior to sending the assistance information indicating the unreceived PDCP SDU at the UE; or
obtain uplink data from the network entity after sending the assistance information indicating the unreceived PDCP SDU at the apparatus.

22. The apparatus of claim 21, wherein the one or more processors, individually or in combination, are further operable to cause the apparatus to:
send a message to the network entity indicating to expect the assistance information from the apparatus prior to scheduling the downlink data, the assistance information being sent after the message is sent.

23. The apparatus of claim 21, wherein the one or more processors, individually or in combination, are further operable to cause the apparatus to:
obtain a PDCP status report of the UE from the network entity, the assistance information being sent in response to the PDCP status report.

24. The apparatus of claim 21, wherein the one or more processors, individually or in combination, are further operable to cause the apparatus to:
send downlink data including a PDCP status report to the network entity, wherein the assistance information indicates the PDCP status report is included in the downlink data.

25. The apparatus of claim 21, wherein the one or more processors, individually or in combination, are further operable to cause the apparatus to:
send a message to the network entity indicating to expect a PDCP status report from the apparatus prior to scheduling uplink data, the PDCP status report being sent after the message is sent.

26. The apparatus of claim 21, wherein the one or more processors, individually or in combination, are further operable to cause the apparatus to:
send downlink data including a message indicating whether an uplink PDCP protocol data unit (PDU) is to be obtained in a retransmission from the UE, the assistance information indicating the message is included in the downlink data, and the message being different than a PDCP status report.

27. The apparatus of claim 21, wherein the one or more processors, individually or in combination, are further operable to cause the apparatus to:
obtain uplink data in response to a message or an expired timer indicating the UE to resume suspended uplink transmissions following a PDCP retransmission trigger at the UE.

28. The apparatus of claim 21, wherein the one or more processors, individually or in combination, are further operable to cause the apparatus to:
obtain a PDCP protocol data unit (PDU) including uplink data from the network entity in response to the assistance information indicating unsuccessful prior reception of the uplink data, wherein the assistance information is sent following a transmission of the uplink data from the UE to the network entity.

29. A method for wireless communication performable at a first network entity, comprising:
obtaining, from a second network entity, assistance information indicating an unreceived Packet Data Convergence Protocol (PDCP) service data unit (SDU) at a user equipment (UE) or the second network entity; and
sending downlink data or an uplink grant to the UE based on the assistance information.

30. A method for wireless communication performable at a first network entity, comprising:
sending, to a second network entity, assistance information indicating an unreceived Packet Data Convergence Protocol (PDCP) service data unit (SDU) at a user equipment (UE) or the first network entity; and
one of:
delivering downlink data to the second network entity prior to sending the assistance information indicating the unreceived PDCP SDU at the UE; or
obtaining uplink data from the second network entity after sending the assistance information indicating the unreceived PDCP SDU at the first network entity.
